(19) United States
(12) Patent Application Publication
(10) Pub. No.: US 2015/0120833 A1
(43) Pub. Date: Apr. 30, 2015

(54) OPTIMIZATION OF PEER-TO-PEER CONTENT DELIVERY SERVICE

(71) Applicant: InterDigital Patent Holdings, Inc., Wilmington, DE (US)

(72) Inventors: Xavier De Foy, Kirkland (CA); Hang Liu, North Potomac, MD (US); Osama Lotfallah, San Diego, CA (US)

(73) Assignee: InterDigital Patent Holdings, Inc., Wilmington, DE (US)

(21) Appl. No.: 14/391,006

(22) PCT Filed: Apr. 5, 2013
(86) PCT No.: PCT/US13/35491

§ 371 Date: Oct. 6, 2014

Related U.S. Application Data
(60) Provisional application No. 61/621,199, filed on Apr. 6, 2012.

(51) Int. Cl. H04L 29/08

(52) U.S. Cl. CPC H04L 67/2842; H04L 67/104
USPC 709/204

(57) ABSTRACT

A method and apparatus are described for providing a dynamic cache function in a network or cloud. A content cache server (CCS) and a lightweight CCS with a dynamic cache function may be deployed in the network or cloud. A tracker may be used to place dynamic cache peers in a peer list, and transmit the peer list to a wireless transmit/receive unit (WTRU). The peer list may include a single peer that is a dynamic cache peer allocated by the tracker to the WTRU, or at least two dynamic cache peers, with one additional “weight” parameter for each dynamic cache peer. The WTRU may connect to the dynamic cache peer with the largest “weight” parameter, and connect to a different dynamic cache peer in the peer list on a condition that the WTRU gets disconnected or gets bad service from the dynamic cache peer with the largest “weight” parameter.

### CROSS-REFERENCE TO RELATED APPLICATIONS

This application claims the benefit of U.S. Provisional Patent Application No. 61/621,199, filed Apr. 6, 2012, titled “Methods and Apparatus for Optimizing Peer-to-Peer Content Delivery Service”, the entire contents of which being hereby incorporated by reference herein, for all purposes.

### BACKGROUND

A content delivery network or system (CDS) may be distributed among one or more servers that may be deployed across the Internet. A CDS may serve content, such as multimedia content to end-users via the Internet with high availability and high performance. Other CDS content may be text, graphics, URLs and scripts, downloadable objects (media files, software, documents), applications (e-commerce, portals), live streaming media, on-demand streaming media, and social networks.

A peer-to-peer (P2P) computer network may be one in which one or more computers in the network can act as a client or server for one or more of the other computers in the network. This may facilitate shared access to various resources such as files, peripherals, and sensors without the need for a central server. P2P networks can be set up within the home, a business, or over the Internet, for example.

### SUMMARY

Embodiments contemplate methods and devices for providing a dynamic cache function in a network or cloud. A content cache server (CCS) and a lightweight CCS with a dynamic cache function may be deployed in the network and/or cloud. A tracker may be used to place one or more dynamic cache peers in a peer list, and may transmit the peer list to a wireless transmit/receive unit (WTRU). The peer list may include a single peer that may be a dynamic cache peer allocated by the tracker to the WTRU, or at least two dynamic cache peers, with one additional “weight” parameter for each dynamic cache peer. The WTRU may connect to the dynamic cache peer with the largest “weight” parameter, and may connect to a different dynamic cache peer in the peer list, perhaps if the WTRU gets disconnected and/or gets bad service from the dynamic cache peer with the largest “weight” parameter.

Embodiments contemplate a dynamic cache peer function in a peer-to-peer content delivery system (P2P CDS) and a mode of operation of P2P content distribution. The mode may be adapted to cellular networks where WTRU peers are proposed to communicate with at least one dynamic cache peer, perhaps in order to limit radio access network usage/congestion. A lightweight P2P protocol may include a set of features that may modify a P2P protocol, perhaps in order to adapt this protocol for use with cellular networks. The IMS P2P CDS architecture may be enhanced by adding a cache peer function, which may be collocated in a CCS node and/or in a lightweight CCS node that may not be interconnected with the tracker and/or content source server (CSS).

Embodiments contemplate additional updates to P2P protocols that may enable a tracker to control the peer list in the WTRU. The IMS P2P CDS architecture may be enhanced by enabling feedback from the network (e.g., including load information), that may be received and/or processed by the tracker, which may adapt the WTRU peers behavior accordingly.

The IMS P2P CDS architecture may be enhanced by enabling CCS nodes and/or lightweight CCS nodes that may be deployed over a private and/or public cloud infrastructure. The CCS instance usage may be controlled by the tracker and/or by a control element that may also be deployed over the cloud infrastructure. Embodiments contemplate a P2P REDIRECT message and an associated procedure that may enable cloud based (L-)CCS deployment.

### BRIEF DESCRIPTION OF THE DRAWINGS

A more detailed understanding may be had from the following description, given by way of example in conjunction with the accompanying drawings wherein:

FIG. 1A shows an example communications system in which one or more disclosed embodiments may be implemented;

FIG. 1B shows an example wireless transmit/receive unit (WTRU) that may be used within the communications system shown in FIG. 1A;

FIG. 1C shows an example radio access network and an example core network that may be used within the communications system shown in FIG. 1A;

FIG. 2 illustrates an example media flow in a first example architecture consistent with embodiments;

FIG. 3 illustrates an example media flow in a second example architecture consistent with embodiments;

FIG. 4A illustrates an example IMS based architecture with a dynamic cache peer function implemented by a content cache server (CCS) consistent with embodiments;

FIG. 4B illustrates a non-IMS based system architecture diagram showing a dynamic cache peer function consistent with embodiments;

FIG. 5A is an example flow diagram of a content delivery establishment technique in an Internet protocol (IP) multimedia subsystem (IMS) peer-to-peer (P2P) content delivery system (CDS) consistent with embodiments;

FIG. 5B is an example flow diagram of a content delivery establishment technique in a non-IMS peer-to-peer (P2P) content delivery system (CDS) consistent with embodiments

FIG. 6A is an example flow diagram of an IMS based media transmission phase technique consistent with embodiments;

FIG. 6B is an example flow diagram of a non-IMS based media transmission phase technique consistent with embodiments;

FIG. 7A is an example flow diagram illustrating characteristics of the lightweight peer-to-peer protocol mode of operation in an IMS architecture consistent with embodiments;

FIG. 7B is an example flow diagram illustrating characteristics of the lightweight peer-to-peer protocol mode of operation in a non-IMS architecture;

FIG. 8A is an example flow diagram illustrating characteristics of the lightweight P2P protocol mode of operation in an IMS architecture consistent with embodiments;

FIG. 8B is an example flow diagram illustrating characteristics of the lightweight P2P protocol mode of operation in a non-IMS architecture consistent with embodiments;

FIG. 9 is a flow diagram of an example content delivery establishment technique when the lightweight P2P protocol mode of operation may be used in an IMS P2P CDS consistent with embodiments;

FIG. 10 is a flow diagram of an example media transmission technique when the lightweight P2P protocol may be used consistent with embodiments;

FIG. 11 is a flow diagram of an example media transmission technique when the lightweight P2P protocol mode of operation may be used consistent with embodiments;

FIG. 12 is a flow diagram of an example content delivery establishment technique when the lightweight P2P protocol mode of operation is used in IMS P2P CDS consistent with embodiments;

FIG. 13 shows an architecture with a dynamic cache peer function implemented by a content cache server (CCS) consistent with embodiments;

FIG. 14 is a flow diagram of an exemplary technique that may be used by a tracker that may be aware of a CCS and/or a lightweight CCS (L-CCS) instance status consistent with embodiments;

FIG. 15 is a flow diagram of an example technique used by a tracker that may not be aware of a CCS and/or a L-CCS instance status consistent with embodiments;

FIG. 16 is a flow diagram of an example technique that may use a redirect message in a P2P protocol;

FIG. 17A is a flow diagram of an example technique in which a tracker may receive events and may react in an IMS based architecture consistent with embodiments;

FIG. 17B is a flow diagram of an example technique in which a tracker may receive events and may react in a non-IMS based architecture consistent with embodiments;

FIG. 18A is a flow diagram of an example technique in which a tracker may receive events and may react in an IMS based architecture consistent with embodiments;

FIG. 18B is a flow diagram of an example technique in which a tracker may receive events and may react in a non-IMS based architecture consistent with embodiments;

FIG. 19A is a flow diagram of an example technique in which a tracker may receive a location update message in an IMS based architecture consistent with embodiments;

FIG. 19B is a flow diagram of an example technique in which a tracker may receive a location update message in a non-IMS based architecture consistent with embodiments;

FIG. 20 shows an example architecture of a generic (non-IMS) over-the-top P2P CDS where dynamic cache peers may be deployed consistent with embodiments; and

FIG. 21 illustrates an example (non-IMS specific) P2P CDS architecture consistent with embodiments.

### DETAILED DESCRIPTION

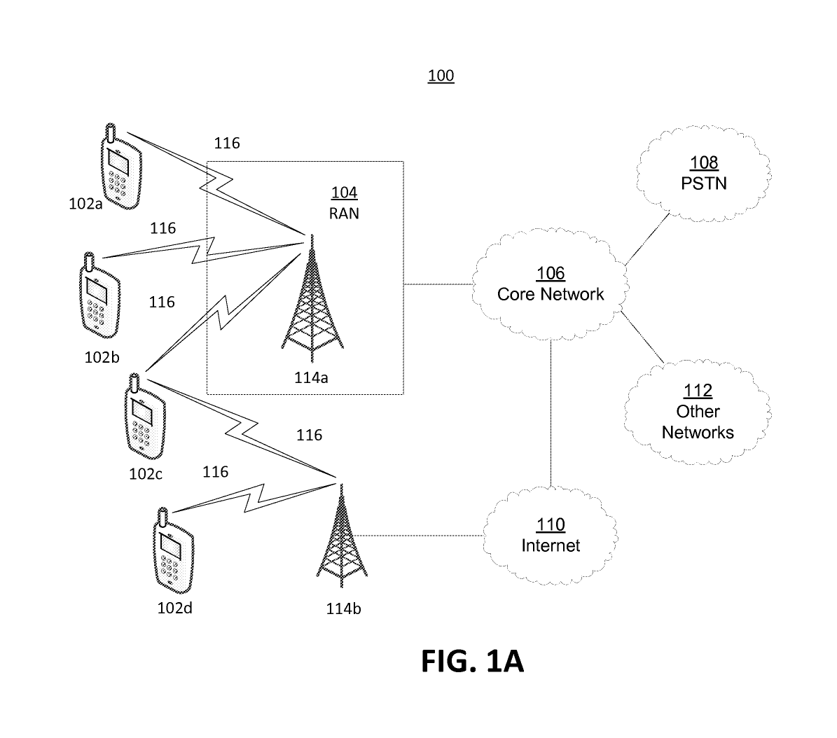

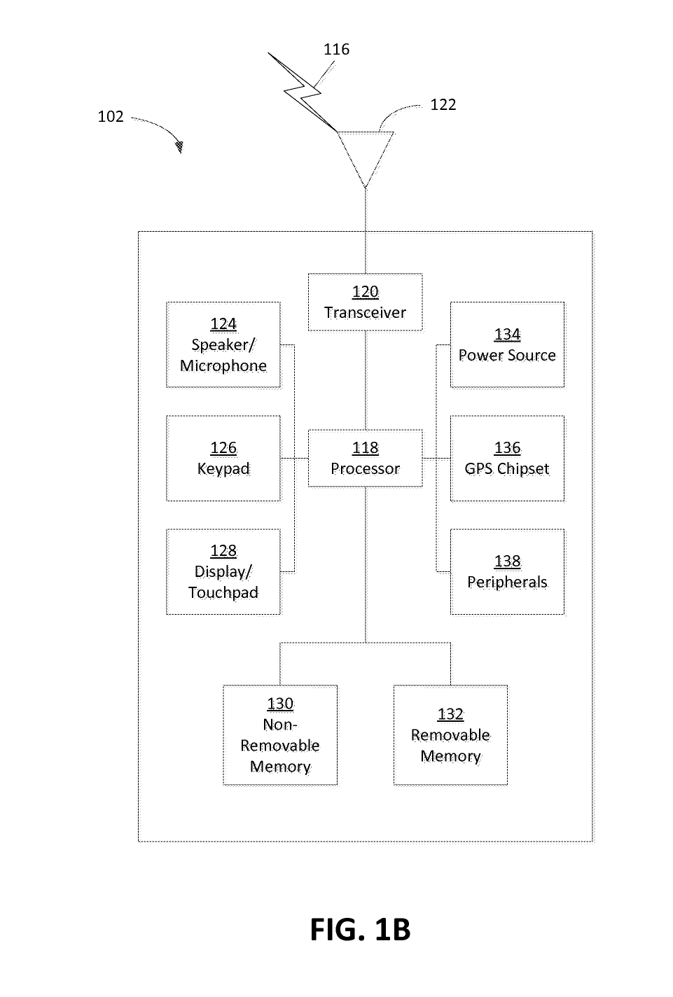

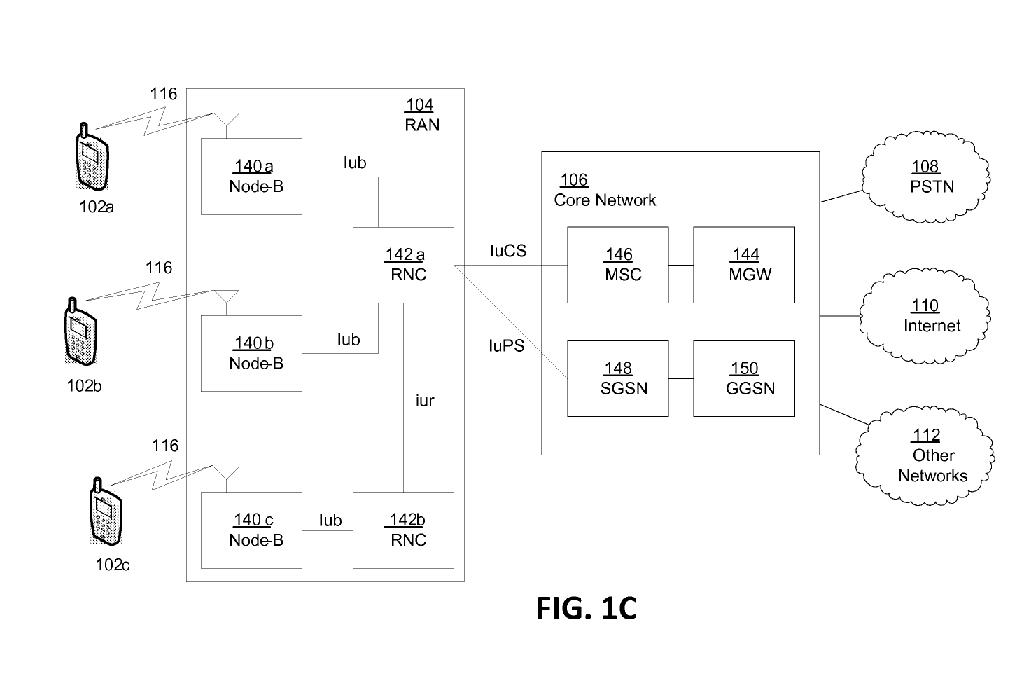

FIG. 1A shows an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink packet access (HSDPA) and/or high-speed uplink packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-Advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1×, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over Internet protocol (VoIP) services to one or more of the WTRUs 102a, 102b, 102c, 102d. For example, the core network 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. The RAN 104 may include any number of Node-Bs and RNCs.

As shown in FIG. 1C, the Node-Bs 140a, 140b may communicate with one another and with the RNC 142a via respective Iub interfaces. Additionally, the Node-B 140c may communicate with the RNC 142b via an Iub interface. Each of the RNCs 142a, 142b may be configured to control the respective Node-Bs 140a, 140b, 140c to which it communicates with. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 1C may include a media gateway (MGW) 144, a mobile switching center (MSC) 146, a serving general packet radio service (GPRS) support node (SGSN) 148, and/or a gateway GPRS support node (GGSN) 150. While each of the foregoing elements are depicted as part of the core network 106, any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

In a third generation partnership project (3GPP) network, a peer-to-peer (P2P) content delivery system (CDS) may be integrated within an Internet protocol (IP) multimedia subsystem (IMS). Data-related signaling may account for data-related payload in terms of download power consumption at a Node-B transmitter of uniform mobile telecommunications system (UMTS) networks. Therefore, a 3GPP network may take this into account and suitably optimize application signaling when possible.

Experimental studies and traffic analysis has shown that 60% to 74% of the IP packets may be control packets in several popular P2P CDSs, including but not limited to PPlive, PPSstreaming, SopCast, and/or QQLive. The control overhead in P2P CDS may be particularly detrimental in cellular networks, perhaps because it may be expected that radio access networks for mobile devices may form a bottleneck. As P2P content consumption may increase in cellular networks, radio access network congestion may become of greater concern, perhaps because of a large number of time-sensitive data segment requests between wireless transmit/receive units (WTRUs), and/or data segment uploads from WTRUs. In addition, control packet transmissions may result in a considerable WTRU battery drain.

Content cache servers (CCSs), also known as network peers, may be deployed by network operators in P2P CDS systems. A CCS may act as a “normal” peer in the sense that it may reply to bitmap requests with a response indicating which data segments it may have currently. If a WTRU does not find a data segment on the CCS, the WTRU may get the data segment from another CCS or another WTRU, which may cause additional signaling and uploads.

When P2P content distribution services may be deployed on cellular networks, it may be desirable that these services may be optimized to reduce the impact on radio access network utilization and/or device power consumption.

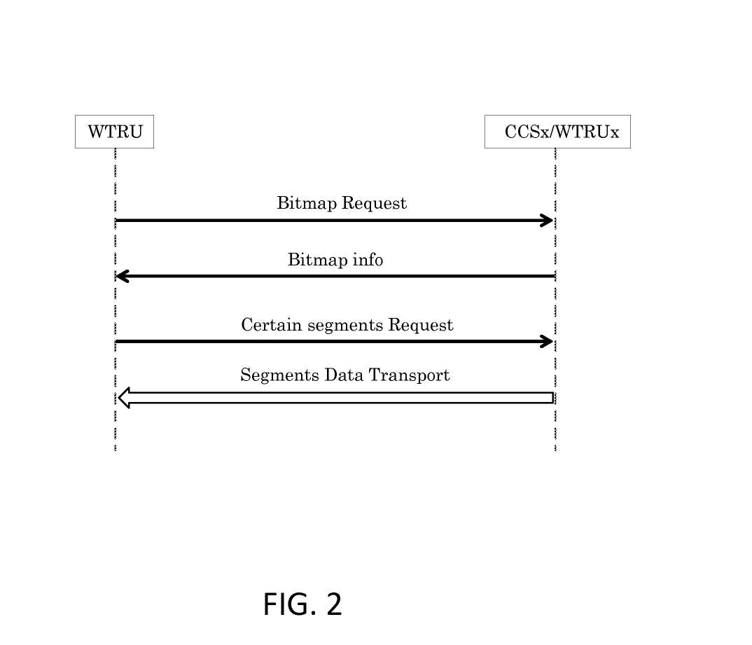

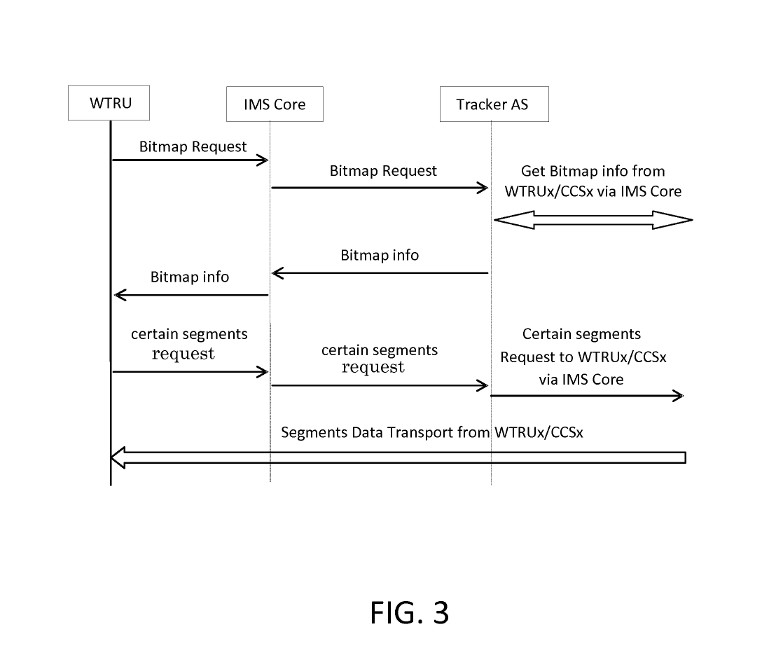

FIG. 2 and FIG. 3 are flow diagrams of respective example multimedia transmissions on respective example architectures. In FIGS. 2 and 3, perhaps after obtaining a peer list from a tracker application server (AS), a WTRU may request a bitmap from one or more, or each, peer in a peer list and may decide, according to a certain algorithm, from which content cache servers (CCSs), (e.g., network peers), or other WTRUs (e.g., acting as user peers), to acquire the content segments. After that, the content delivery system (CDS) WTRU may fetch content segments from one or more selected peers. In some embodiments, it may take at least three control messages for a peer to obtain a data segment. When a WTRU has several peers, it may contact one or more, or all, of such peers. Thus, in some embodiments, the amount of control signaling may increase dramatically.

One or more of the techniques and devices described herein may be applicable to any P2P CDSs (e.g., non-IMS based P2P CDSs and/or IMS-based P2P CDSs). Although IMS-based P2P signaling and/or over-the-top, non-IMS, P2P signaling may be used as examples, the techniques and devices described herein are not limited to IMS P2P CDS.

One or more embodiments described herein may reduce inter-peer signaling overhead, and in some embodiments particularly the signaling messages sent or received by a WTRU (e.g., perhaps since these signaling messages may pass through radio access links). One or more embodiments may limit uploads from one or more WTRUs, perhaps as much as possible, in peer-to-peer Content Distribution System (P2P CDS), such as over-the-top P2P CDS (e.g., Joost, PPLive) or IMS P2P CDS. Internet Engineering Task Force (IETF) drafts, such as draft-ietf-ppsp-survey-03, lists a number of P2P CDS systems (e.g., called P2P streaming applications in the draft) contemplated by embodiments.

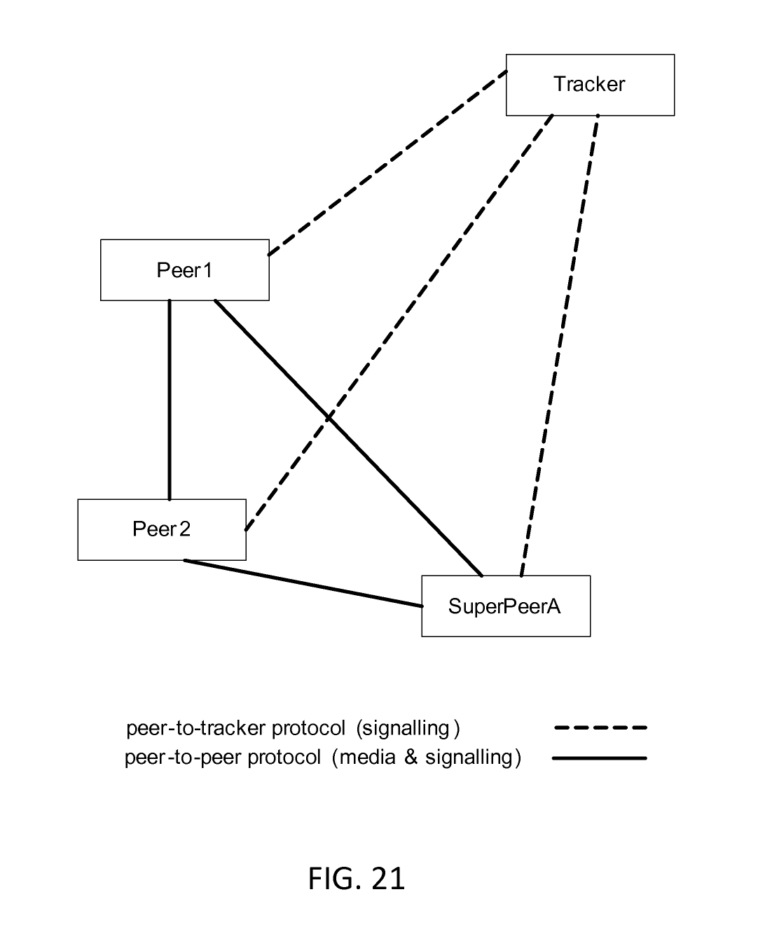

An example (non-IMS specific) P2P CDS architecture contemplated by one or more embodiments is illustrated in FIG. 21. SuperPeers such as SuperPeer A may have more CPU/bandwidth capacity than a regular peer (e.g., a non-dynamic cache peer). Also, some SuperPeers (and/or perhaps regular peers Peer 1 and/or Peer 2) may obtain a first copy of the content to distribute (e.g., the P2P CDS operator may own some or all SuperPeers, and may initially provision content on these SuperPeers).

A WTRU may use a lightweight P2P protocol mode with one or more “dynamic cache peers” (DCP), and by doing so may minimize the signaling and data overhead from a WTRU (e.g., user peer) to other peers. For example, a network may direct a WTRU to contact one or more dynamic cache peers, and perhaps not regular peers. When the available dynamic cache peers may not be able to handle the traffic load, the WTRU (which may be a peer to other WTRUs) may be instructed to contact other WTRU peers, perhaps using load feedback from the network to regulate the amount of WTRU peer to WTRU peer interconnections. In one or more embodiments, the WTRU may get content from a dynamic cache peer and/or some other WTRUs (e.g., peers), and the amount of direct WTRU peer to WTRU peer activity may be limited in order not to overuse the access network resources. A balance may be determined by experimentation by the network operator, and the settings may be set as a network operator policy that many be enforced by the tracker, for example.

In one or more embodiments, a lightweight P2P protocol mode, (e.g., a mode of operation of the P2P protocol), perhaps in some embodiments with one or more related procedures, may be used for media transmission between the peers. The lightweight P2P protocol may reduce the number of control signaling messages that may be used by a peer to get a data segment from another peer. In some embodiments, the CCS nodes present in a P2P CDS architecture may be used as dynamic cache peer. Alternatively or additionally, lightweight CCS (L-CCS) nodes, (which for example may be equivalent to CCS nodes that may have no interface with a content source server (CSS)), may be used as dynamic cache peers. An L-CCS may be deployed in the core network, on the Internet, in customer premises, (e.g., in home gateways), and/or in public or private clouds.

In a non-IMS context, any SuperPeer (or even normal peer) may be used as a dynamic cache peer. Such a SuperPeer may be deployed by a cellular network's operator, perhaps in order to reduce the impact of P2P traffic on network resources, among other reasons. In such scenarios, SuperPeers used as dynamic cache peers may or may not have a non-P2P interface to content source servers (CSS).

Additionally, a P2P CDS tracker may react to events in the network or from WTRUs, and may adapt the peer list or lists delivered to WTRUs (and/or perhaps new WTRUs). The P2P CDS tracker may retroactively modify the peer list of the existing WTRU peers. These events may include, but are not limited to, one or more radio access network overload indications, and/or WTRU location changes.

One or more embodiments contemplate a P2P CDS that may support one or more WTRUs (for example) over cellular/other wireless technologies and/or other technologies (e.g., using a P2P approach). One or more embodiments contemplate that one or more dynamic peer caches may be used in a lightweight P2P protocol mode for peer list control, perhaps based on network status, among other factors. One or more embodiments contemplate that at least two types of WTRUs may interoperate with each other within the same P2P CDS and/or even within the same swarm [[NOTE—let's define “swarm” somehow]]. In some embodiments, a swarm may refer to a group of peers who may exchange data to distribute chunks of the same content at a given time or substantially at a given time, for example. One or more embodiments may facilitate the widespread adoption of existing over-the-top P2P Content Delivery Systems by cellular networks subscribers, while perhaps limiting the impact on cellular networks.

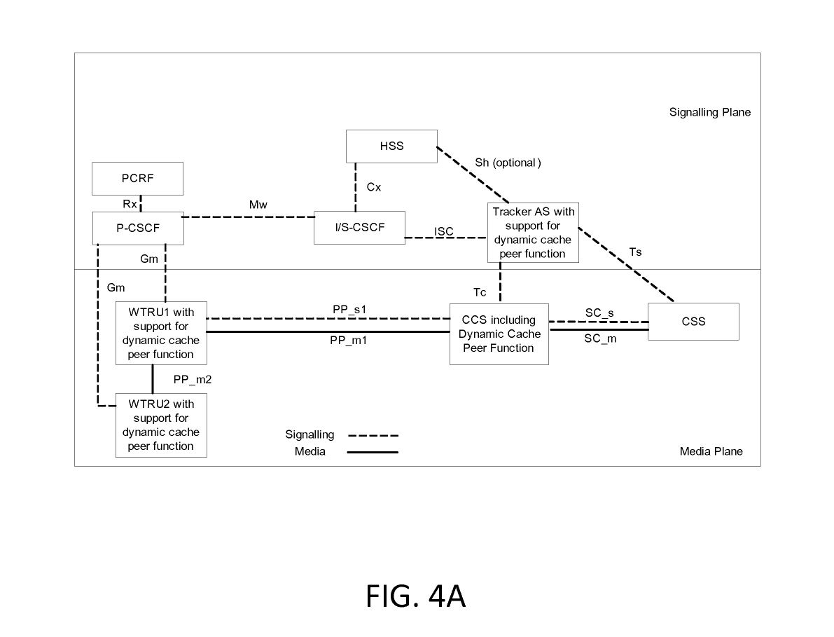

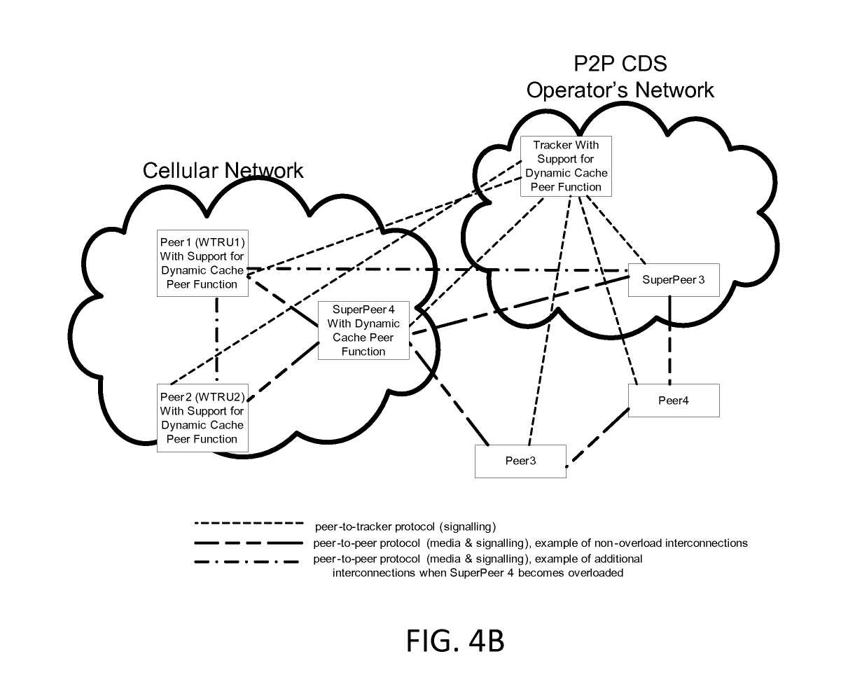

FIG. 4A and FIG. 4B illustrate respective examples of architectures with a dynamic cache peer function implemented by a CCS. In these architectures, WTRU-WTRU signaling may (e.g., FIG. 4A) pass through an IMS. These architectures may also be applicable if WTRU-WTRU signaling does not pass through an IMS (e.g. FIG. 4B). In one or more embodiments, a CCS entity of a P2P CDS architecture may be used as a dynamic cache peer (perhaps in addition to performing as a static cache that may acquire content from a CSS and delivering this content using a P2P protocol). Referring to FIG. 4A, in some embodiments, a tracker may place one or more dynamic cache peers in a peer list, perhaps associated with a “dynamic cache peer” flag.

In one or more embodiments, the peer list sent by the tracker may include a single peer, which may be the dynamic cache peer allocated by the tracker to this WTRU.

In one or more embodiments, the tracker may include two or more dynamic cache peers in the list, perhaps with one additional “weight” parameter for each dynamic cache peer. In some embodiments, the WTRU may connect to the dynamic cache peer with the largest weight. In some embodiments, perhaps under particular circumstances—such as for example if the WTRU may get disconnected and/or may get bad service from this dynamic cache peer—the WTRU may connect to the second peer.

In one or more embodiments, the WTRU may connect to two or more dynamic cache peers simultaneously.

In one or more embodiments, the tracker may add regular WTRU peers in the peer list. The WTRU may use the dynamic cache peer(s) in priority, and then may get data segments from regular peers when/if the dynamic cache peers may not provide the data segments (e.g., provide the data segments on time). In some embodiments, perhaps when a WTRU may establish peer relationship with fewer peers, the number of the WTRU's control signaling messages may be reduced. The techniques described herein to give a single cache peer and/or including a ranking in the peer list may enable a WTRU to establish the peer relationship with at least one stable high-throughput peer, (e.g., a cache peer), perhaps in order to maintain satisfactory quality.

In the architecture of FIG. 4A, WTRU-CCS signaling may not pass through an IMS core. Alternately or additionally, this architecture may also be applicable if WTRU-CCS signaling passes through an IMS core, but in such scenarios there may be no PP_s1 and perhaps instead there may be a new “Gm” interface between a CCS and a proxy call session control function (P-CSCF), for example.

Alternatively or additionally to the description of FIG. 4A, FIG. 4B illustrates an example non-IMS architecture implementing a dynamic cache peer may include an over-the-top P2P CDS system (e.g., a tracker-based P2P IPTV described in draft-ietf-ppsp-survey-03) that may have different clients, including home desktop PCs or other home appliances, and cellular devices (not explicitly shown). The over-the-top P2P CDS provider may deploy a tracker and one or more SuperPeers (e.g., SuperPeer 3) that may be accessible from the Internet. Perhaps to reduce the impact of P2P on its network, the cellular network's operator may deploy one or more SuperPeers (e.g., SuperPeer 4) with a dynamic cache peer function in its core network. The tracker may be made aware of this dynamic cache peer (DCP) (e.g. through an application layer traffic optimization (ALTO), not shown). WTRU1 and WTRU2 may be told by the tracker to use this SuperPeer 4 as a dynamic cache peer (DCP). Perhaps at some point, may be if SuperPeer4 becomes unable to serve one or more, or all WTRUs, WTRU1 and/or WTRU2 may start to obtain data chunks from other peer (e.g., the WTRUs may gradually fallback to usual P2P behavior). For example, where the DCP may be the sole source of content for WTRU1 and/or WTRU2, as the load on the DCP may increase, the DCP may not be able to serve some or all content. In such scenarios, WTRU1 may obtain part of the content from other peers (e.g., SuperPeer 3 and/or WTRU2).

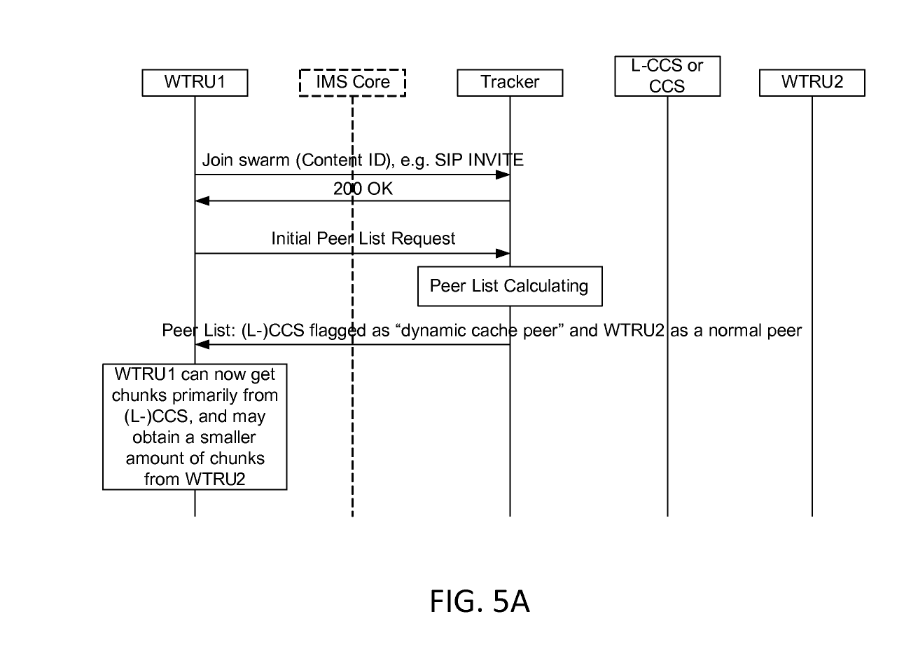

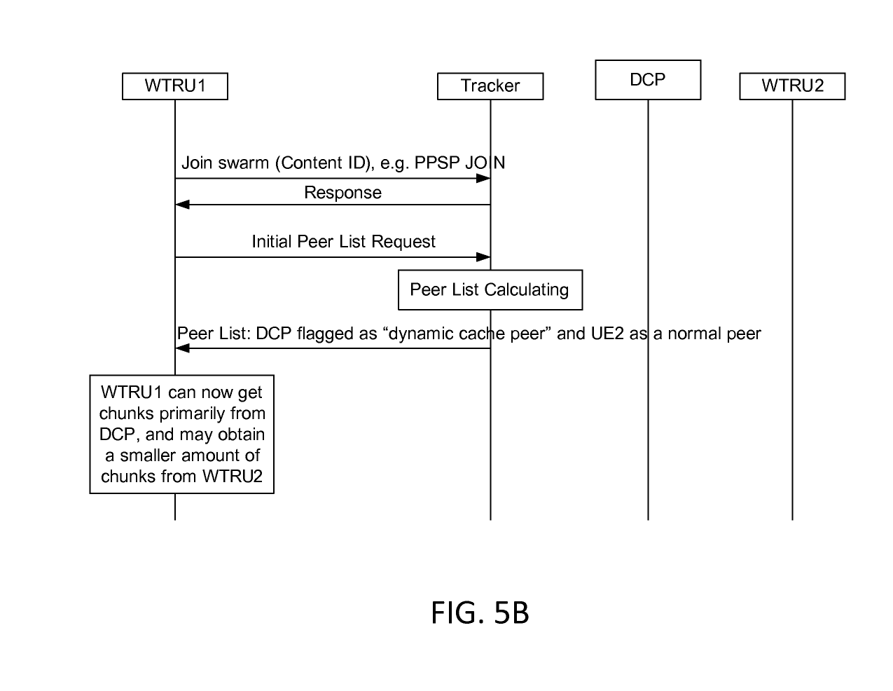

FIG. 5A illustrates an example message flow describing the Content Delivery Establishment procedure in an IMS based P2P CDS.

FIG. 5B illustrates an example message flow describing the Content Delivery Establishment procedure in a non-IMS based P2P CDS. The tracker may obtain assistance from an ALTO server (not shown), perhaps to prepare the peer list, for example.

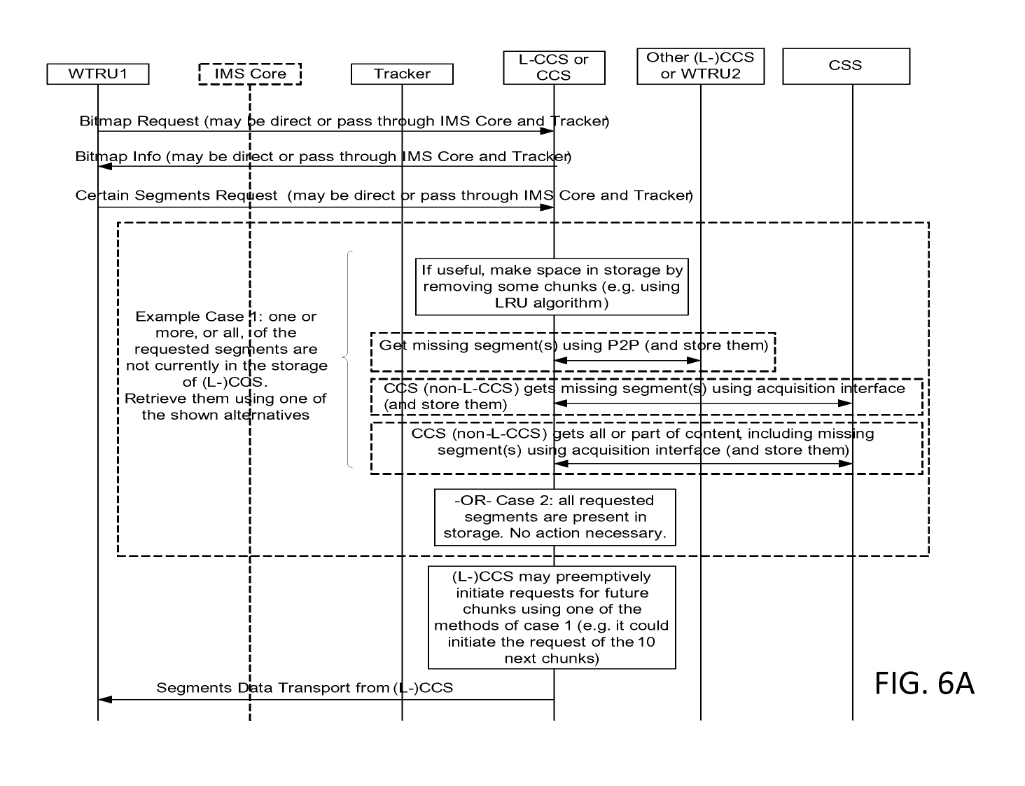

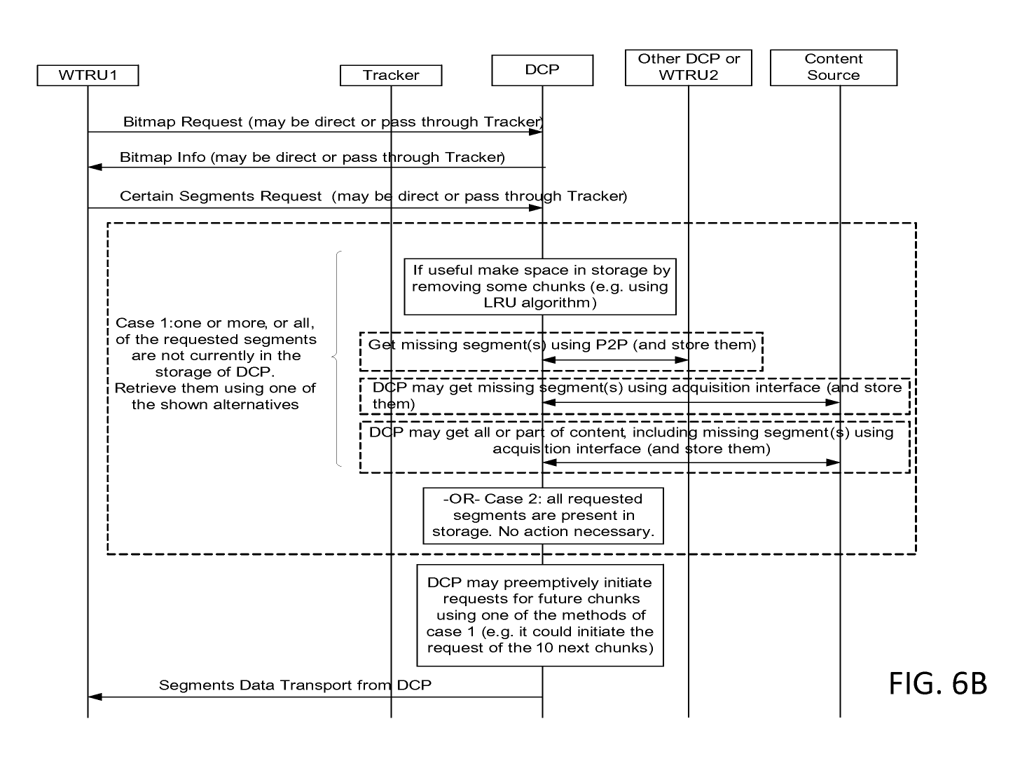

FIG. 6A is an example flow diagram of an IMS based media transmission phase procedure. An L-CCS and/or CCS may act as a dynamic cache peer. In some embodiments, perhaps upon reception of a request from a WTRU, the dynamic cache peer may check if the requested segment(s) may be in a cache and (perhaps if not) may acquire the requested segments from peers and/or a CCS. The dynamic cache peer may send the requested segments to the requester. In some embodiments, the (L-)CCS may perform some pre-fetching, (e.g., of the whole content or of the next n data segments), perhaps to reduce latency. In some embodiments, some messages may pass through an IMS core and/or tracker, perhaps depending on the IMS P2P CDS architecture. This may not influence the general usage of the dynamic cache peer, as shown in FIG. 6A. In some embodiments, perhaps if WTRU1-CCS signaling may be passing through the IMS core and/or the tracker, CCS-CCS and/or CCS-WTRU signaling may also pass through IMS and/or the tracker as well (not shown).

FIG. 6B is an example flow diagram of a non-IMS based media transmission phase procedure. In FIG. 6B, a SuperPeer may act as a dynamic cache peer (DCP). In some embodiments, perhaps upon reception of a request from WTRU1, the dynamic cache peer may check if the requested segment(s) are in the cache. If the requested segments are not in the cache, the DCP may acquire the requested segments and may send the requested segments to the requester. In some embodiments, the DCP may perform some pre-fetching (e.g. of the whole content or of the next n data segments), perhaps to reduce latency.

Alternatively or additionally, in one or more embodiments, the WTRU may use a lightweight P2P protocol mode when communicating with the dynamic cache peer. The use of this protocol may further reduce the amount of P2P signaling in and/or out of the WTRU (e.g., to save radio access bandwidth and/or reduce mobile battery power consumption).

The following embodiments, which may be referred to generally as scenario A-D may be used for contemplated amendments to the original P2P protocol (e.g., P2P streaming protocol (PPSP)). Although the scenarios may be labeled as A-D, the labeling is provided for explanation and not for limitation. The various scenarios and the corresponding embodiments may be implemented individually or in combination—either in part or in total—with other scenarios and corresponding embodiments.

In a scenario A, perhaps when the tracker sends a peer list to a WTRU, the tracker may add per-entry (e.g., per-peer) information elements that may indicate that a given peer implements the lightweight P2P protocol mode described herein, perhaps along with a version and/or supported features.

In a scenario B, the WTRU may not request a bitmap from a dynamic cache peer supporting the lightweight P2P protocol mode of an operator. In some embodiments, the WTRU may assume that the dynamic cache peer may have one or more, or all, the data segments of the content in the swarm and/or can retrieve them from another source. Alternatively or additionally, in some embodiments, the dynamic cache peer may not request the bitmap from the WTRU. In some embodiments, no data segment advertisement may occur between the WTRU and the dynamic cache peer, perhaps except for a scenario D described herein. For example, in the case of PPSP, a “HAVE” message may not be sent by either party.

In a scenario C, the data segment(s) request sent by the WTRU may hold a heretofore undefined “lightweight mode” flag that may indicate that the data segment(s) may be retrieved by the peer, perhaps if the peer may not have the data segment(s) in its storage. In some embodiments, the flag may enable a SuperPeer (e.g., an L-CCS in IMS) to act as a dynamic cache peer and/or a regular peer, perhaps depending on the request. For example, WTRUs communicating over 3G may use CCS as a dynamic cache peer, (perhaps because the tracker may have marked the CCS as a dynamic cache peer in the peer list), while other WTRUs over a wireless local area network (WLAN) may use CCS as a regular peer.

In a scenario D, the dynamic cache peers may perform P2P statistics reporting to the tracker on-behalf of the WTRU peers. In one or more embodiments, perhaps where a WTRU may have at least one dynamic cache peer and may not have other peers, the dynamic cache peer may know the data segment bitmap from this WTRU without any extra signaling. In some embodiments, this may be extended to cover scenarios where the WTRU peer may be connected to other peers, for example.

In some embodiments, perhaps when sending a data segment request to a dynamic cache peer, the WTRU may piggy back a list of data segments that may have been recently received from one or more other peers. Alternatively or additionally, in some embodiments the information piggybacked in the data segment request may be the WTRU data segment bitmap, perhaps “as is” and/or in a compressed format, (e.g., derived from a binary delta compression algorithm, where the original may be the previous data segment bitmap, and the different version may be the different data segment bitmap, perhaps excluding some or any data segment that may be obtained from this dynamic cache peer). In some embodiments, perhaps when sending a data segment request to a dynamic cache peer, the WTRU may add a flag indicating if the dynamic cache peer may be its only peer. Perhaps if this is not the case, the dynamic cache peer can request data segment bitmaps from the WTRU on a periodic basis, for example. In some embodiments, the bitmap reply from the WTRU may be compressed.

Scenarios A, B and C may be independent from each other. For example, in one or more embodiments, scenarios A, B, and/or C may be implemented, and perhaps in other embodiments scenarios A and B may be implemented. At least one alternative or addition to implementing scenario B is that one or more, or all, data segment requests reaching a dynamic cache peer may be considered as lightweight mode. At least one alternative or addition to implementing scenario A may be that one or more, or all, dynamic cache peers may support the lightweight P2P protocol mode of operation.

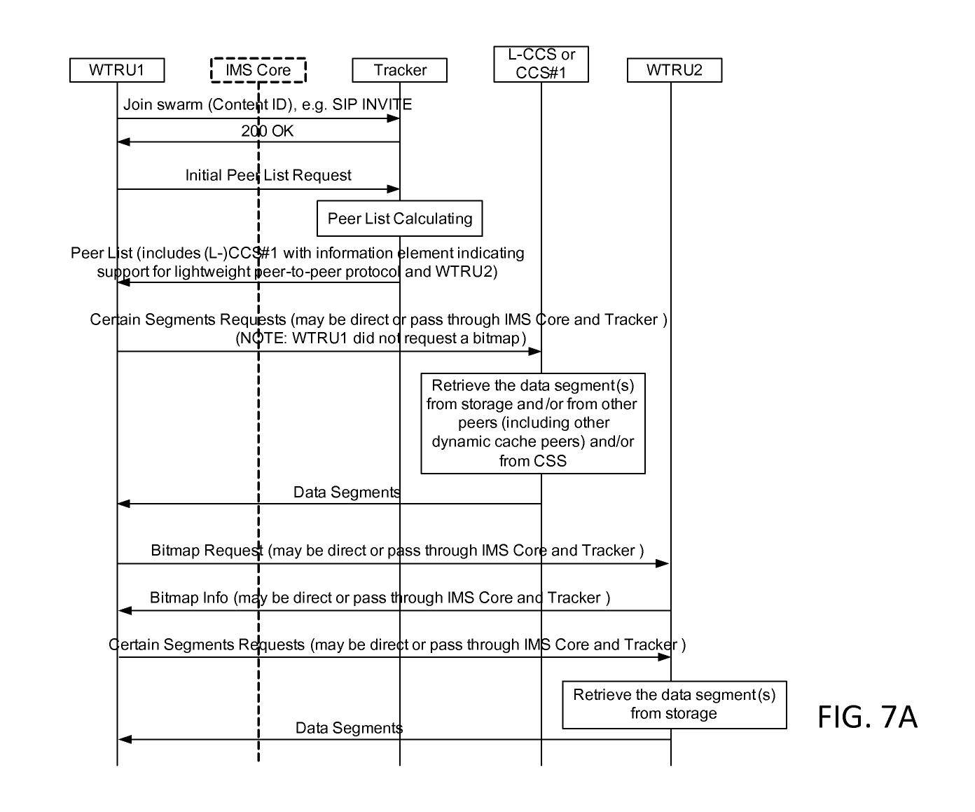

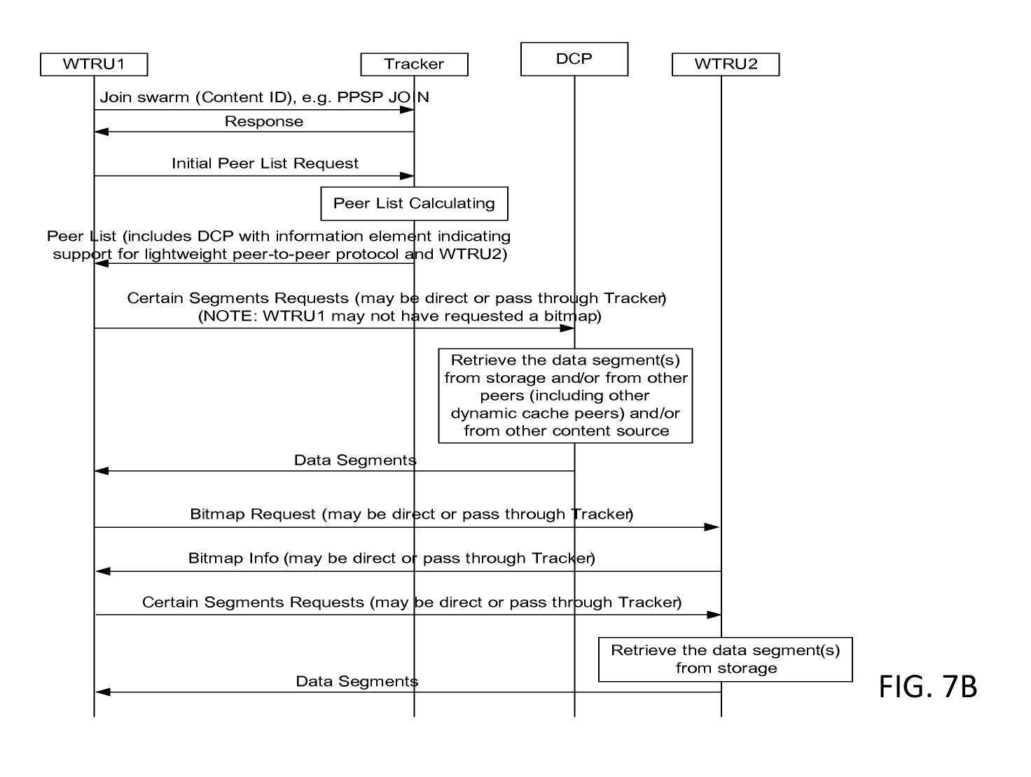

FIG. 7A is an example flow diagram illustrating characteristics of the lightweight peer-to-peer protocol mode of operation in an IMS architecture. In the example of FIG. 7A, the peer list may include at least one dynamic peer list and at least one regular WTRU peer.

FIG. 7B is an example flow diagram illustrating characteristics of the lightweight peer-to-peer protocol mode of operation in a non-IMS architecture. In the example of FIG. 7B, the peer list may include at least one dynamic peer list and at least one regular WTRU peer.

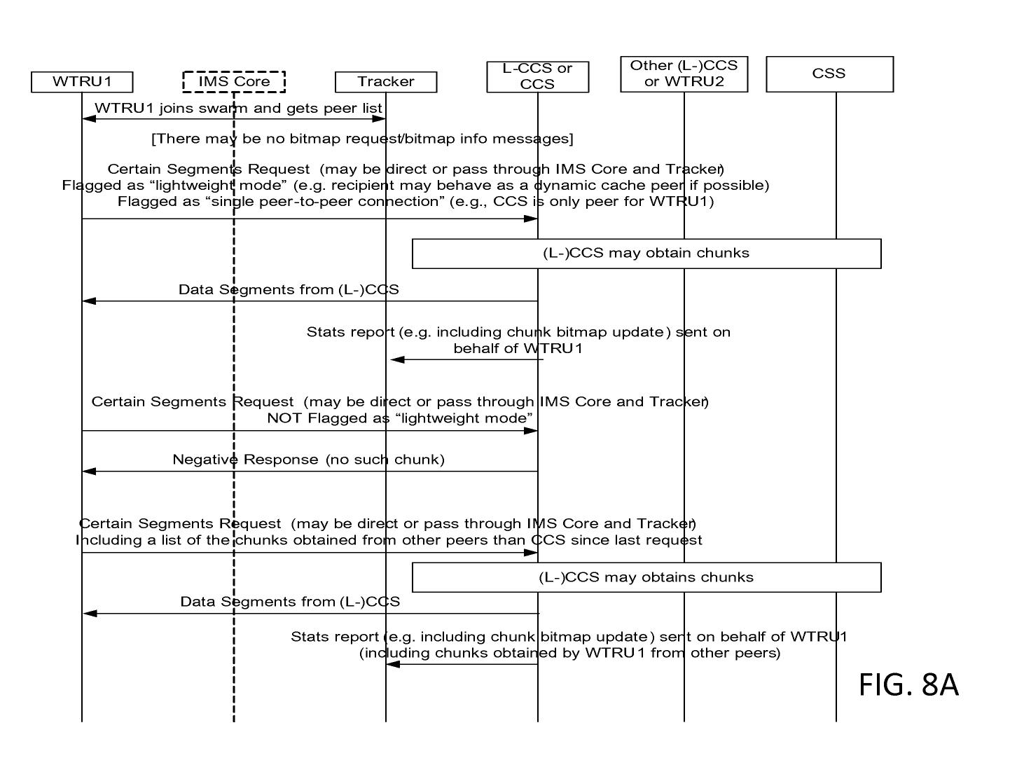

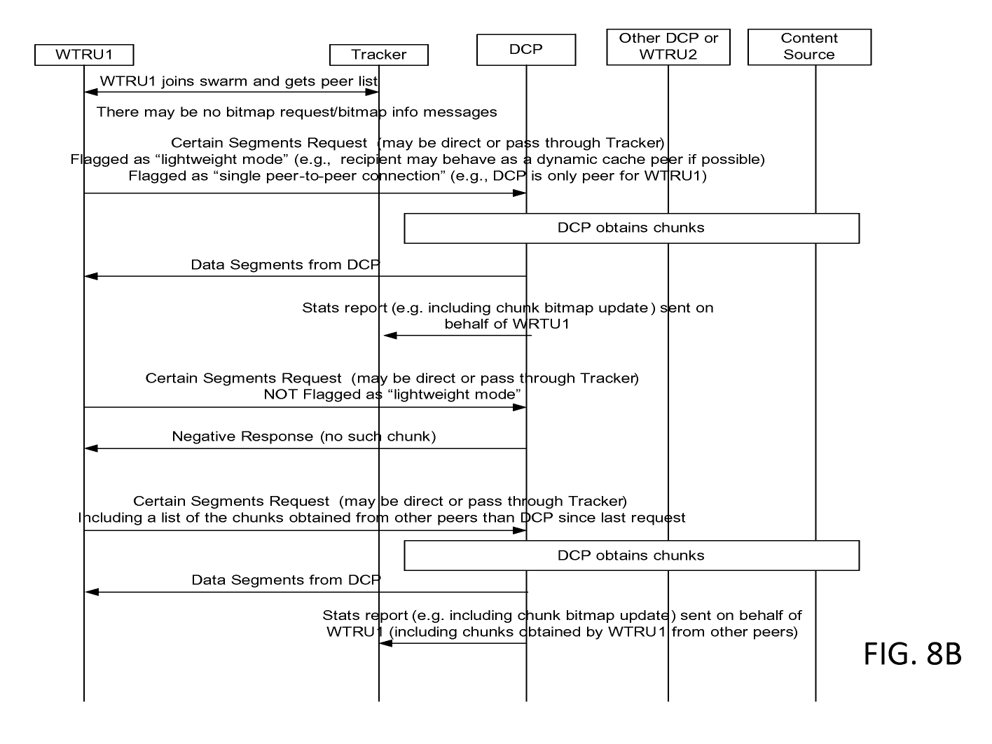

FIG. 8A is an example flow diagram illustrating characteristics of the lightweight P2P protocol mode of operation in an IMS architecture.

FIG. 8B is an example flow diagram illustrating characteristics of the lightweight P2P protocol mode of operation in a non-IMS architecture.

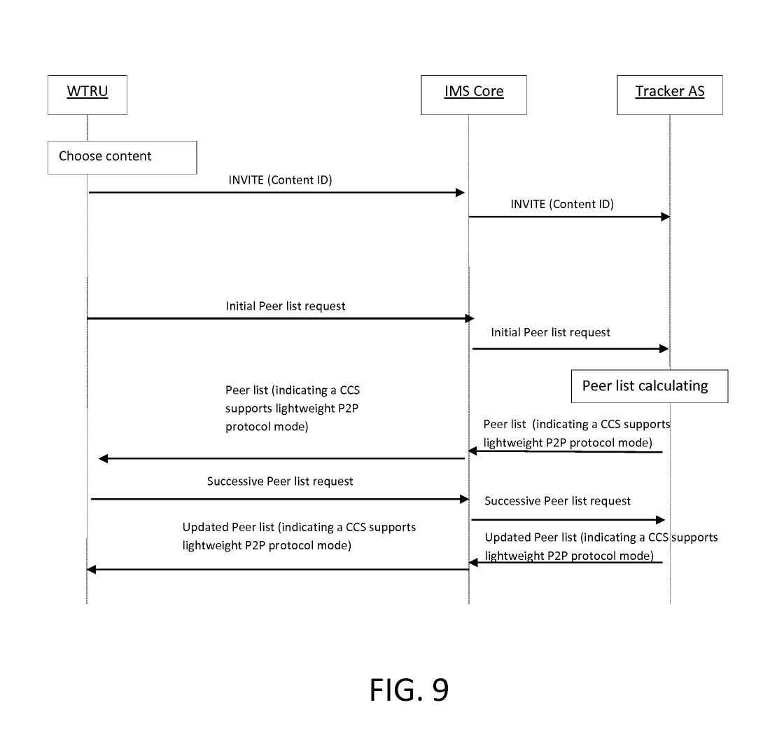

FIG. 9 is a flow diagram of an example content delivery establishment procedure when the lightweight P2P protocol mode of operation may be used in IMS P2P CDS. As shown in FIG. 9, a tracker AS may add an information element in the peer list that may indicate that a CCS supports the lightweight P2P protocol mode of operation.

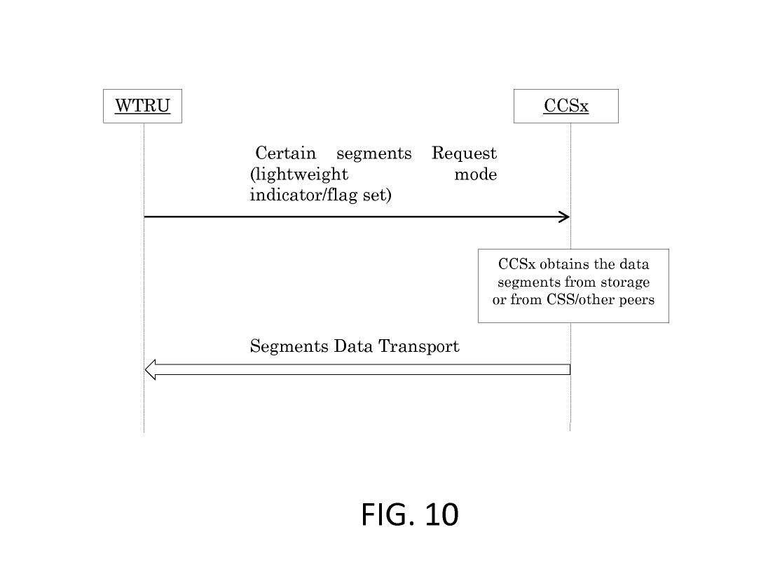

FIG. 10 is a flow diagram of an example media transmission procedure when the lightweight P2P protocol mode of operation may be used. In FIG. 10, the segments requests can be marked with a “lightweight mode” flag, as described herein. In some embodiments, CCSx may act as a dynamic cache peer.

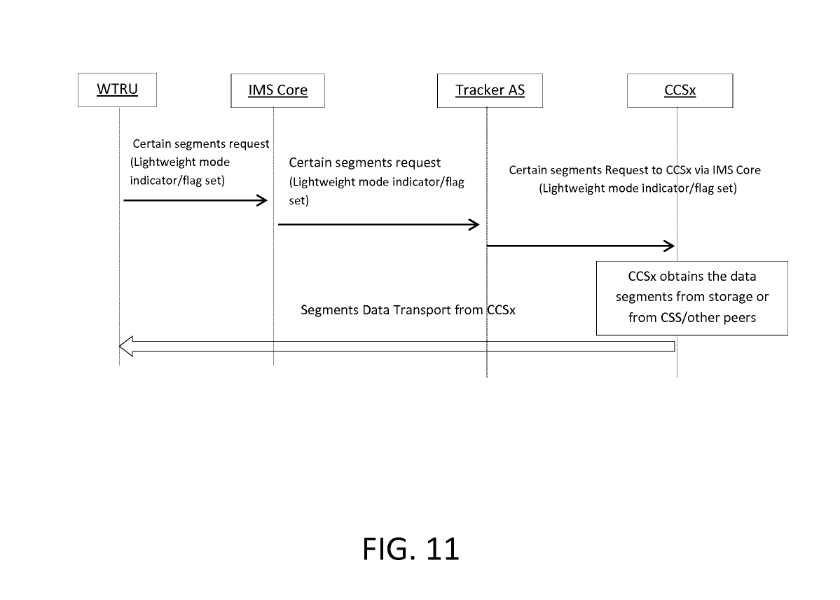

FIG. 11 is a flow diagram of an example media transmission procedure when the lightweight P2P protocol mode of operation may be used. The segment requests may be marked with a “lightweight mode” flag, as described herein. In some embodiments, the CCSx may act as a dynamic cache peer.

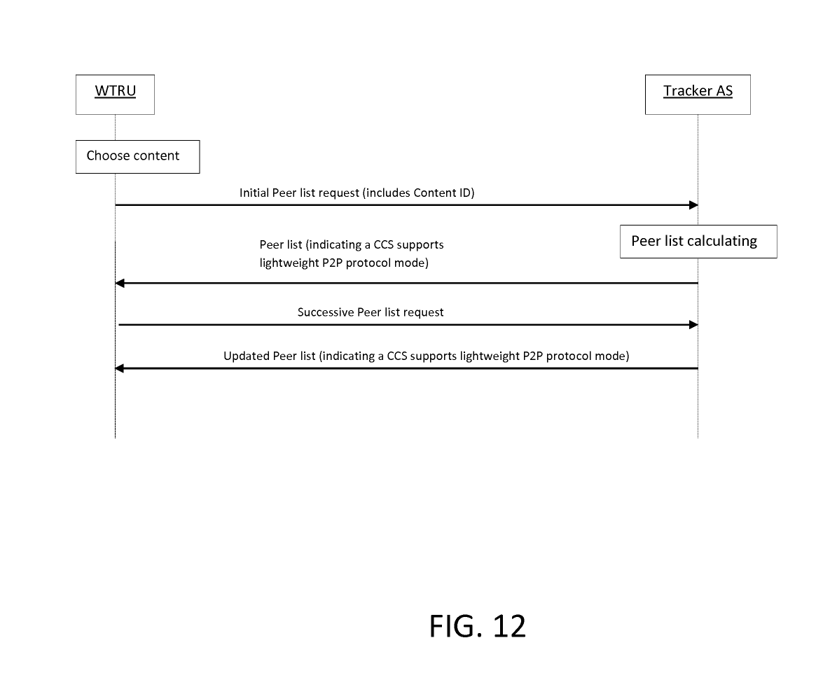

FIG. 12 is a flow diagram of an example content delivery establishment procedure when the lightweight P2P protocol mode of operation may be used in IMS P2P CDS. As shown in FIG. 12, a tracker AS may add an information element in the peer list that may indicate that a CCS may support the lightweight P2P protocol mode of operation, for example.

One or more embodiments contemplate that having a single peer and/or a known number of peers per WTRU may reduce the amount of signaling that may be used to obtain content. It also may enable using a lightweight P2P protocol mode to get the content data segments, because there may be a unique peer and/or a known number of peers.

One or more embodiments contemplate that having a single or a small number of peers may simplify a quality of service (QoS)/charging setup, perhaps since it may make it possible to configure filters for a dedicated bearer using a small number of filters, perhaps within 16 filters, for example.

One or more embodiments contemplate that a dynamic cache peer (DCP) may reduce the number of uploads from regular peers, perhaps because the cache may act as an in-network storage for the content data segments (e.g. perhaps for as long as they stay in the cache). For example, embodiments recognize that in-network storage for P2P may result in a reduction of upload below 3% of its original value before using in-network storage.

In one or more embodiments, dynamic caches may be deployed in lightweight CCS nodes, which in some embodiments may act solely as a dynamic cache, (e.g., such nodes may not have an interconnection with a CSS—which may present them from acquiring content directly from CSS). In one or more embodiments, CCS and/or lightweight CCS may be deployed with a dynamic cache function in a network. For example, a CCS acting as dynamic cache may decide to acquire the whole content, (e.g., a movie), from a CSS, perhaps in response to a request from one or more data segments for this content. A lightweight CCS may obtain the content from one or more other peers or CCSs, perhaps using P2P protocol. In some embodiments, perhaps depending on the content characteristics, (e.g., presence on a CSS, content popularity; live vs. on-demand, etc.), it may be useful to use one or the other. Perhaps due to its lack of an SC_s/SC_m interface, a lightweight CCS may be more suitable than a non-lightweight CCS to be located outside of the core network, (e.g., a home gateway or other device located on customer premises).

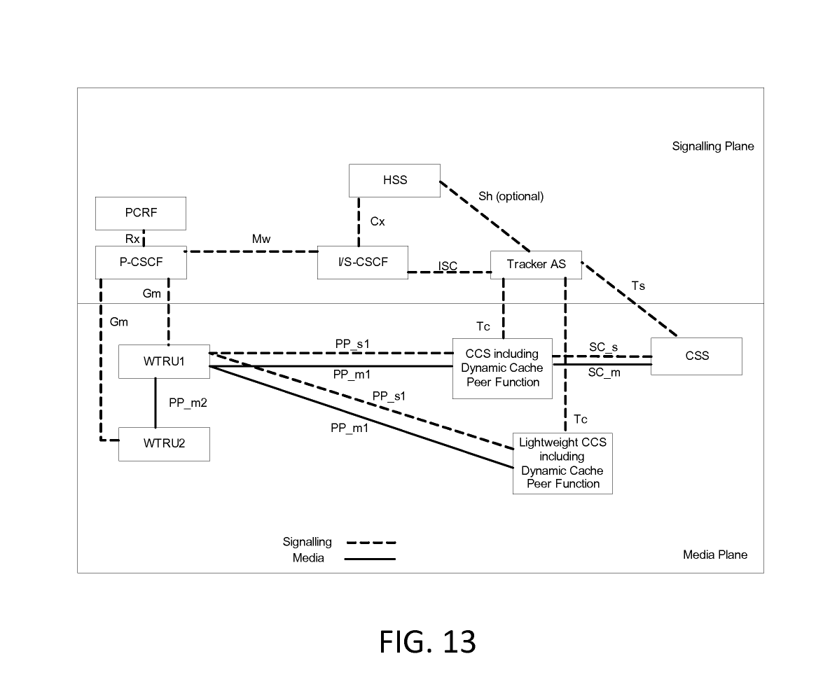

FIG. 13 shows an example architecture with a dynamic cache peer function implemented by a CCS. In some embodiments, WTRU-WTRU signaling may pass through an IMS core, but may also be applicable if WTRU-WTRU signaling may not pass through an IMS core. In some embodiments, WTRU-CCS signaling may not pass through an IMS (“PP_s1”). In some embodiments, WTRU-CCS signaling may pass through an IMS core, and perhaps in such scenarios there may be no PP_s1 and instead there may be a different “Gm” interface between a CCS and a P-CSCF.

In one or more embodiments, perhaps instead of being deployed in the core network or on the customer premises, a CCS or lightweight CCS may be deployed in a cloud, (e.g., they may be deployed as a software service on top of cloud computing services, such as Amazon S3 or Microsoft Azure). In another example, CCS or lightweight CCS may be deployed in a private cloud, (e.g., as software over a computing service platform operated by the cellular network operator in the core network). This last example may enable cloud bursting, (e.g., deploying dynamically, on-demand, new CCS/lightweight CCS instances in a public cloud to temporarily increase the caching capacity that may be deployed in the private cloud).

One or more embodiments contemplate a selection of the proper CCS and/or lightweight CCS instance for a given WTRU. In the non-cloud cases, this selection may be performed by the tracker. For example, the tracker may select a CCS for one or more, or all, WTRUs, perhaps using a given packet data network (PDN) gateway and entering a given swarm. This may ensure that this CCS (and in some embodiments perhaps only this CCS) may hold a copy of the content distributed by this swarm. In some embodiments, perhaps if too many WTRUs join the swarm, the tracker may select a second CCS, or the like.

In one or more embodiments, different strategies may be used in the cloud case. In some embodiments, the tracker may trigger the creation of one or more CCS/lightweight CCS instances for a given swarm. For example, if the swarm may be localized in North America, a CCS instance (and perhaps in some embodiments, perhaps a single instance) in North America may be created. For a more global swarm, one or more instances may be created in Asia, North America and/or Europe. The tracker may then allocate a given CCS instance to a WTRU, perhaps depending on parameters such as but not limited to a WTRU and/or a CCS instance location or CCS instance load. In some embodiments, the tracker may designate the CCS/lightweight CCS as a service, (e.g., using a fully qualified domain name (FQDN)). The entry point to the cloud service may create new (and/or different) CCS instances as may be useful, and may redirect the WTRU towards the proper instance. In some embodiments, this may employ a redirection mechanism, which may be done for example using domain name system (DNS) redirection (e.g. like in some current content distribution networks (CDNs)), and/or a heretofore undefined redirection message that may be introduced in the P2P protocol (e.g., in PPSP). For example, in response to a data segment request from a WTRU, the redirector component of the CCS cloud may reply with a “permanent redirection” message towards a CCS instance. This CCS instance may later redirect the WTRU towards another instance or towards the redirector (e.g., using the same mechanism), perhaps in order to implement mobility support or load balancing.

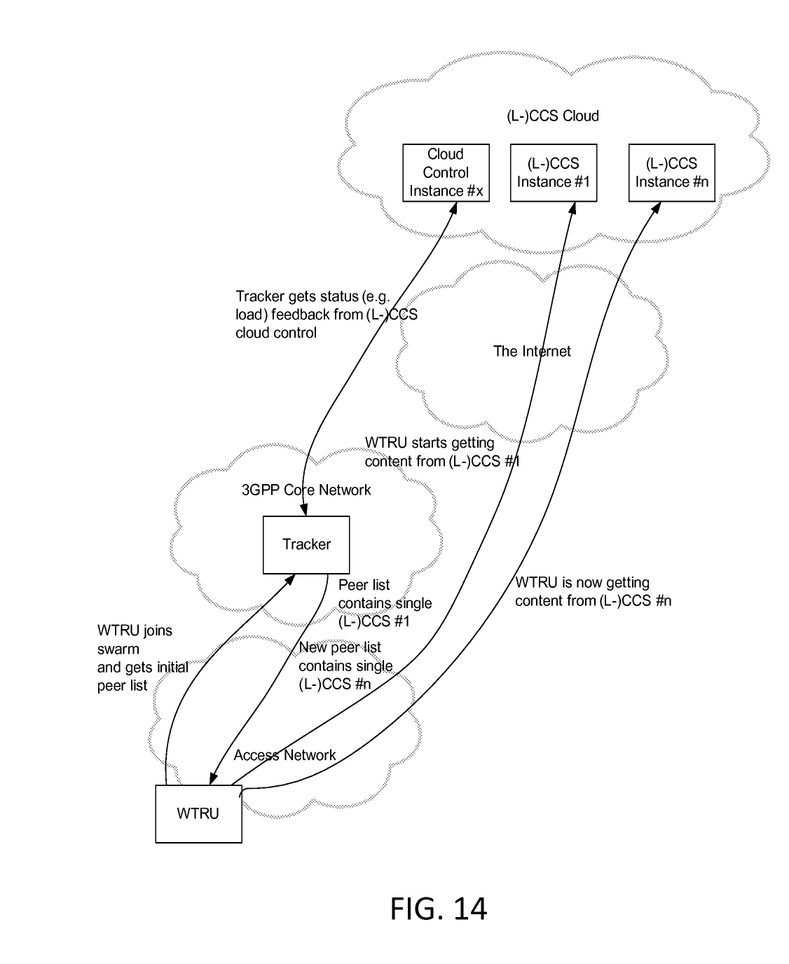

FIG. 14 is a flow diagram of an example procedure used by a tracker that may be aware of a CCS and/or a lightweight CCS (L-CCS) instance status to allocate a proper instance to new (e.g. recently recognized) WTRU peers, and/or redirect existing peers towards different instances.

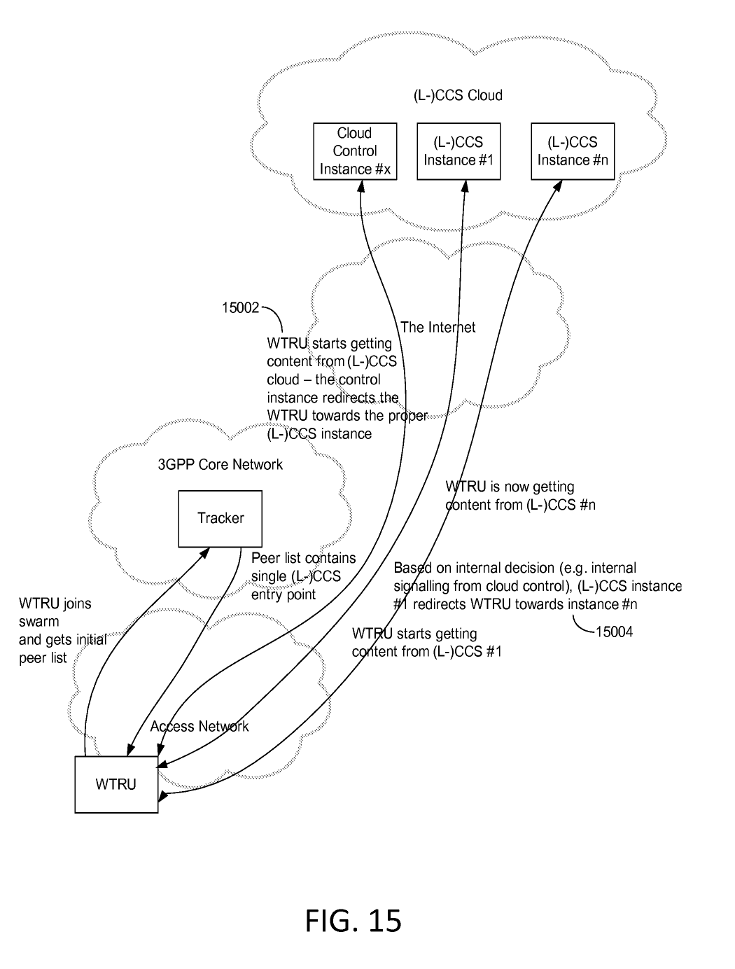

FIG. 15 is a flow diagram of an example procedure used by a tracker that may not be aware of a CCS and/or a L-CCS instance status. The tracker may send a peer list pointing to a single (L-)CCS identity, (e.g., FQDN), to one or more new (e.g. recently recognized) WTRU peers. Actual distribution between (L-)CCS instances may be performed by the cloud. As shown in FIG. 15, in some embodiments, the aspects associated with 15002 and/or 15004 may be performed using the same P2P redirection message, for example.

Some embodiments contemplate a new (e.g., heretofore undefined) PPSP message REDIRECT (e.g., that may include a target destination identity, such as a FQDN). In some embodiments, this REDIRECT message may be, for example, sent back by a peer in response to a HINT message from another peer. The recipient of a REDIRECT message may disconnect from the sender peer and may connect to the new peer.

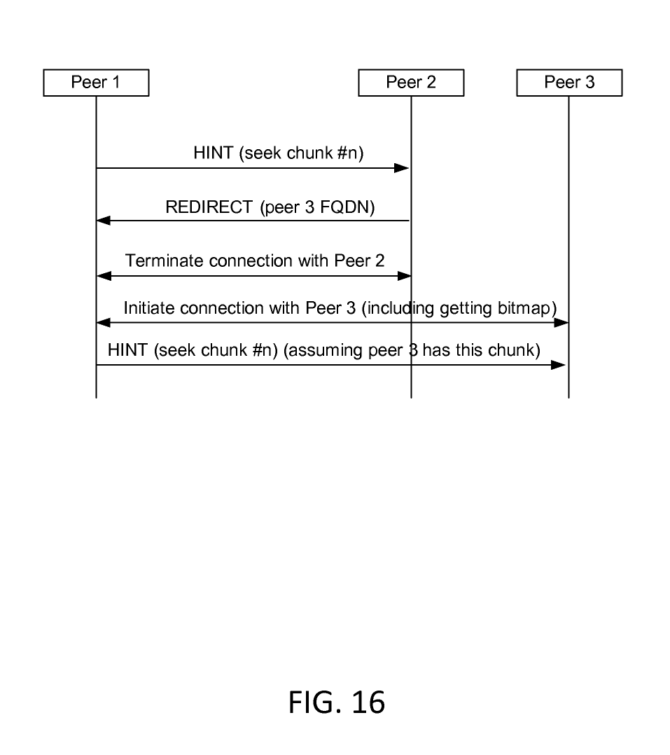

FIG. 16 is a flow diagram of an example procedure that may use a REDIRECT message in a P2P protocol (e.g., P2PSP). This message flow illustrates an example usage of the REDIRECT message in PPSP. Some embodiments contemplate that the IMS P2P CDS protocol may be different from PPSP. A REDIRECT message may be introduced in the IMS P2P CDS protocol, perhaps in order to enable cloud-based caching, as described herein. In some embodiments, perhaps if the lightweight P2P protocol mode may be used and peer2/peer3 may be dynamic cache peers, peer 1 may not obtain the bitmap from peer 3, as is shown in FIG. 16.

One or more embodiments contemplate that one or more SuperPeers may be implemented in a public cloud and/or a private cloud. In a non-IMS CDS, one or more SuperPeers may be deployed in a cloud. Such SuperPeers may act as DCP. The techniques described in regard to FIG. 15 and/or and FIG. 16 can be used in such non-IMS CDS contexts. In one or more such embodiments, the contemplated message “REDIRECT” may be implemented in PPSP peer-to-peer protocol, for example.

In one or more embodiments, a tracker may provide one or more dynamic cache peers, perhaps as peers in the peer list that may be sent to the WTRU. The tracker may decide to add normal WTRUs in the peer list. The tracker may take load information obtained from the network into account when calculating the peer list of a WTRU. The source of this load information may be, for example, the CCS, a load detection function (LDF), and/or the access network discover and selection function (ANDSF). In some embodiments, this information may be indirectly made available to the tracker, for example through ALTO. For example, an ALTO server in the cellular operator's network may be interconnected with one or more of ANDSF/LDF/etc. and may obtain load information and/or other events. In some embodiments, such an ALTO server may either be directly queried by the tracker, or may be queried through other ALTO servers outside of the cellular network.

In some embodiments, perhaps based on this load information, the tracker may decide (e.g., directly and/or indirectly, perhaps being told by an ALTO server) to provide a single dynamic cache peer in the peer list returned to the WTRU. Alternatively or additionally, the tracker may decide, (e.g., if one or more, or all, available dynamic cache peers are overloaded and/or if the radio access network may not be overloaded), to add regular WTRUs in the peer list.

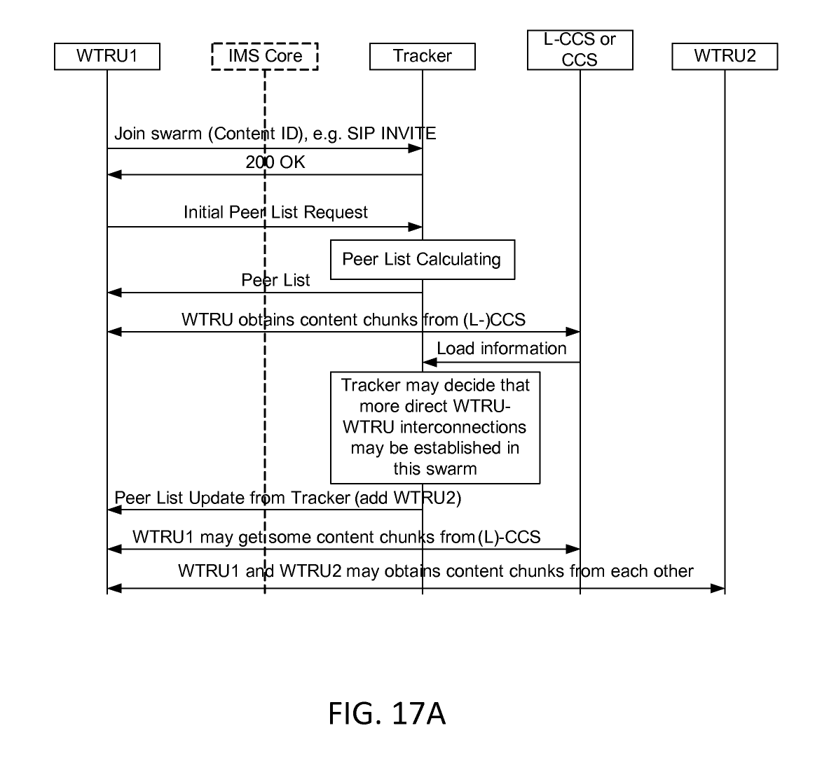

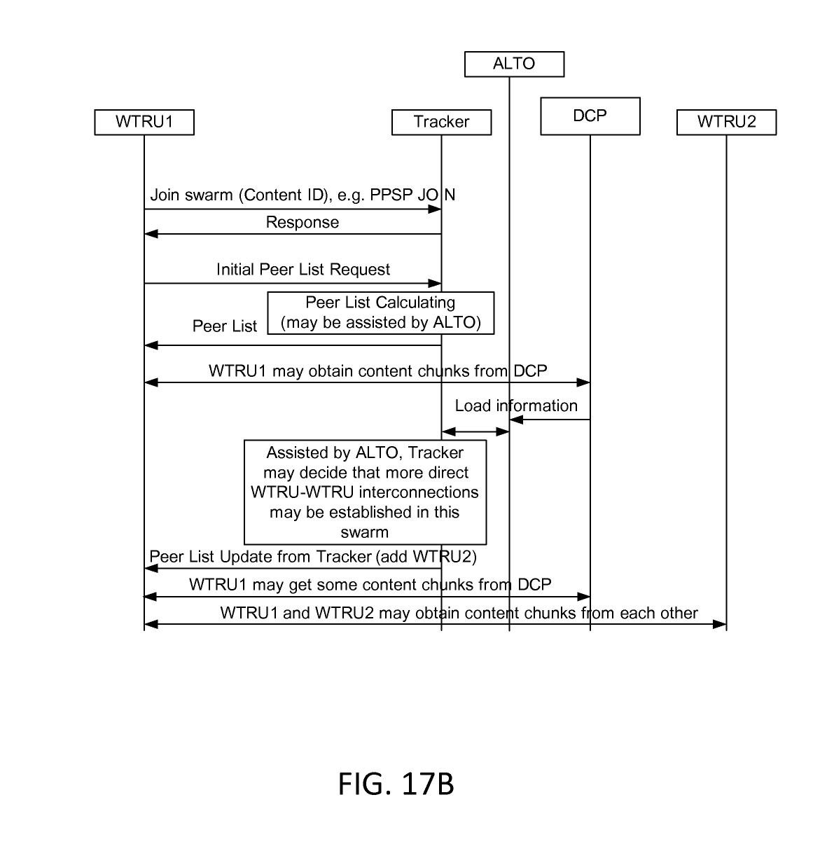

FIG. 17A is a flow diagram of an example procedure in which a tracker may receive events and may react, perhaps by adjusting a peer list in an IMS based architecture. As shown in FIG. 17A, the tracker may update the peer list of WTRU1, perhaps by using one or more new (e.g., recently updated) peer list messages which may be unrequested.

FIG. 17B is a flow diagram of an example procedure in which a tracker may receive events and may react, perhaps by adjusting a peer list in a non-IMS based architecture. As shown in FIG. 17B, the tracker may update the peer list of WTRU1, perhaps by using one or more new (e.g., recently updated) peer list messages which may be unrequested. In some embodiments, the load information may pass through the ALTO. In some embodiments the ATLO—or at least the ALTO function—may be distributed among one or more nodes.

Embodiments recognize that, perhaps once a WTRU gets a peer list, the WTRU may use this information to connect to any device in the peer list. If the network gets overloaded, it may be useful for the tracker to have a way to tell the WTRU not to use a particular peer. One or more embodiments contemplate that the tracker may send an unrequested peer list to the WTRU. Alternatively or additionally, in some embodiments this peer list may enable removing peers from the peer list currently maintained by the WTRU. The actual encoding of this removal may be performed in one or more ways.

In some embodiments, a peer list may be marked as an “overwrite” by the tracker. This information element may indicate to the WTRU that any previously obtained peer list may now be obsolete and may be replaced by this new (e.g., recently updated) peer list. Existing connections to peers not present in the new peer list may be dropped at an earliest convenience, (e.g., after the end of the current data segment download and/or after a time out).

In some embodiments, a peer list may be marked “removed”. The WTRU may remove one or more, or all, peers present in this list from its current internal peer list, and/or may drop connections to a removed peer or peers. In some embodiments, individual peers in the peer list may be marked “removed”. In some embodiments, the peer list may include both added and removed peers.

In one or more embodiments, additional information elements may influence the behavior of the WTRU when processing the peer list from the tracker. For example, an “urgent” flag may be used to drop connections to removed peers immediately, perhaps even if in the middle of a transmission or reception. Also by way of example, a “lazy” flag may be used to continue communication with the removed peers indefinitely, perhaps until the client may take the decision to drop, (e.g., when other connections are ‘up-to-speed’ and the client may judge the obsolete peer may not be useful any longer). And also by way of example, a “passive” flag may be used to stop requesting content from removed peers but perhaps continue serving content data segments to the removed peers upon requests from the removed peers.

In one or more embodiments, a load information update that may be obtained from the network may trigger a re-computation of the peer lists for WTRUs which already may have received a peer list. In some embodiments, perhaps if there is any change, the update peer list may be sent to the WTRU using the “overwrite” and/or, (e.g., perhaps in case of major overload), with the “urgent” flag, for example.

In one or more embodiments, for example in a non-IMS case, the reporting function and DCP may pass information through an intermediary (e.g. an ALTO server that may be deployed by the cellular network operator). The tracker may query the ALTO service, perhaps to learn about the available (e.g. candidate) peers/SuperPeers/DCP in an area. The ALTO service may be a global service that may include the ALTO server deployed by the cellular network operator. In non-IMS cases, a pull model may be utilized. For example, the WTRU may decide to update its peer list from the tracker (e.g. perhaps upon detecting a location change, and/or a deteriorating QoE). The tracker may query the ALTO service. In some embodiments, the cellular network ALTO server may have (e.g., either already, or may be able to retrieve) up-to-date information about the DCP load and/or WTRU location, perhaps because it is interconnected with the DCP and/or the reporting function. Alternatively or additionally, in some embodiments, a “push” model may be utilized in which the ALTO service may initiate the procedure by notifying the tracker.

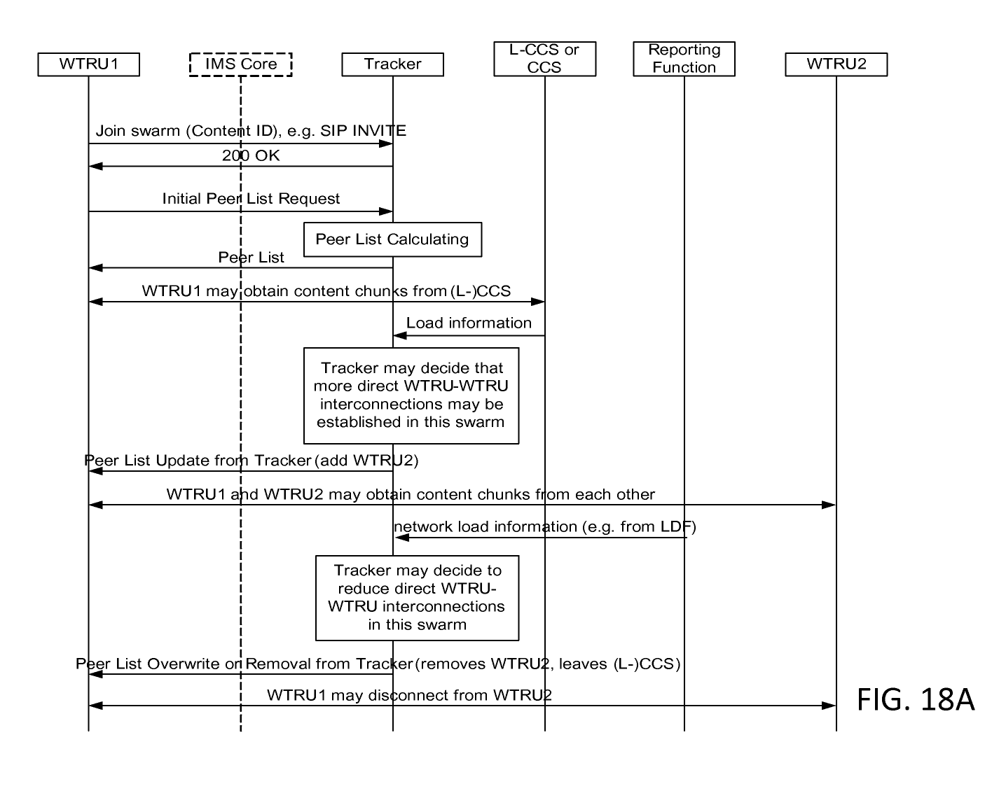

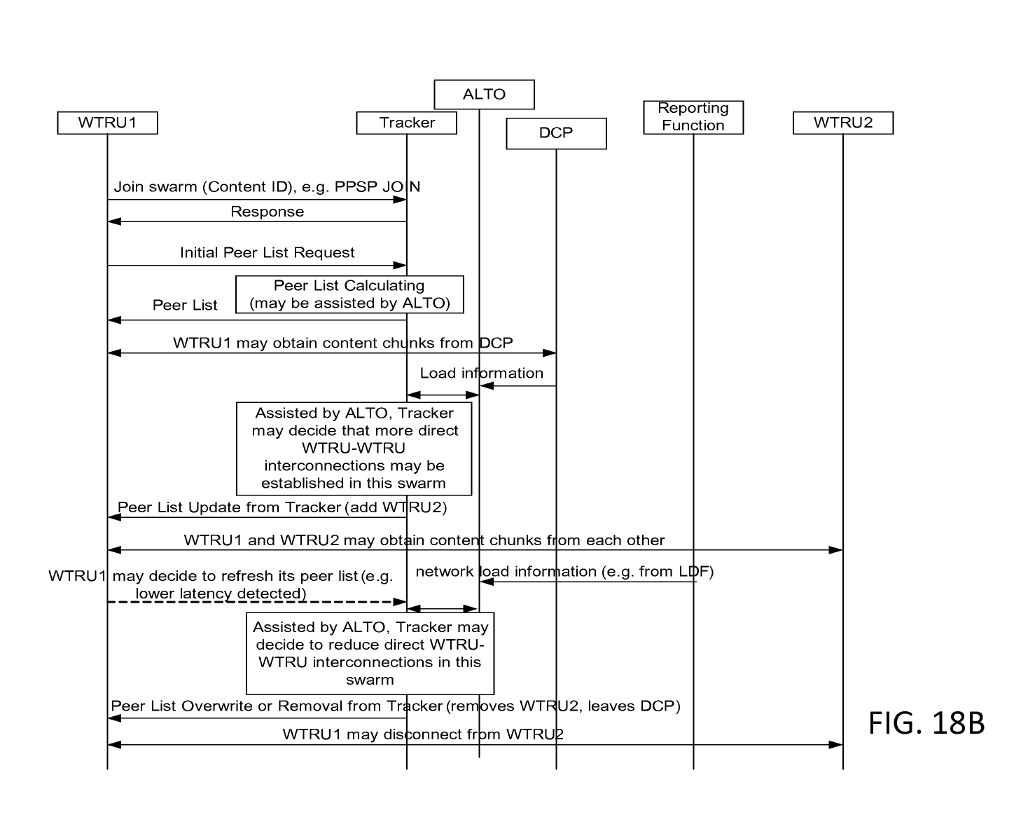

FIG. 18A is a flow diagram of an example procedure in which a tracker may receive events and may react, perhaps by adjusting a peer list in an IMS based architecture. As shown in FIG. 18A, the tracker may update the peer list of WTRU1 using new (e.g. recently updated) peer list messages, which may be unrequested. In some embodiments, the tracker may be able to remove peers from WTRU1's peer list, perhaps in order to respond to a network event, such as a network load event, for example.

FIG. 18B is a flow diagram of an example procedure in which a tracker may receive events and may react, perhaps by adjusting a peer list in a non-IMS based architecture. As shown in FIG. 18B, the tracker may update the peer list of WTRU1 using new (e.g. recently updated) peer list messages, which may be unrequested. In some embodiments, the tracker may be able to remove peers from WTRU1's peer list, perhaps in order to respond to a network event, such as a network load event, for example. In some embodiments, the technique of FIG. 18B may utilize a push model (e.g., the network load information message may trigger the update). In some embodiments, the pull model may be utilized, as indicated by the dotted-line arrow from WTRU1 (e.g. WTRU1 may trigger the peer list update), for example.

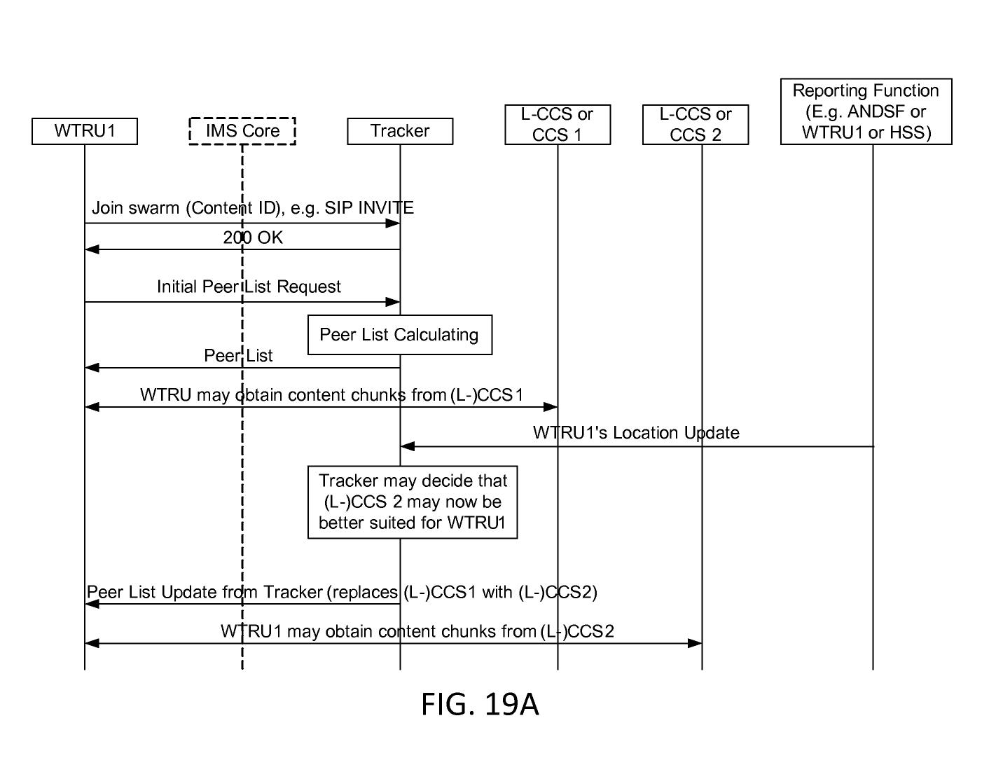

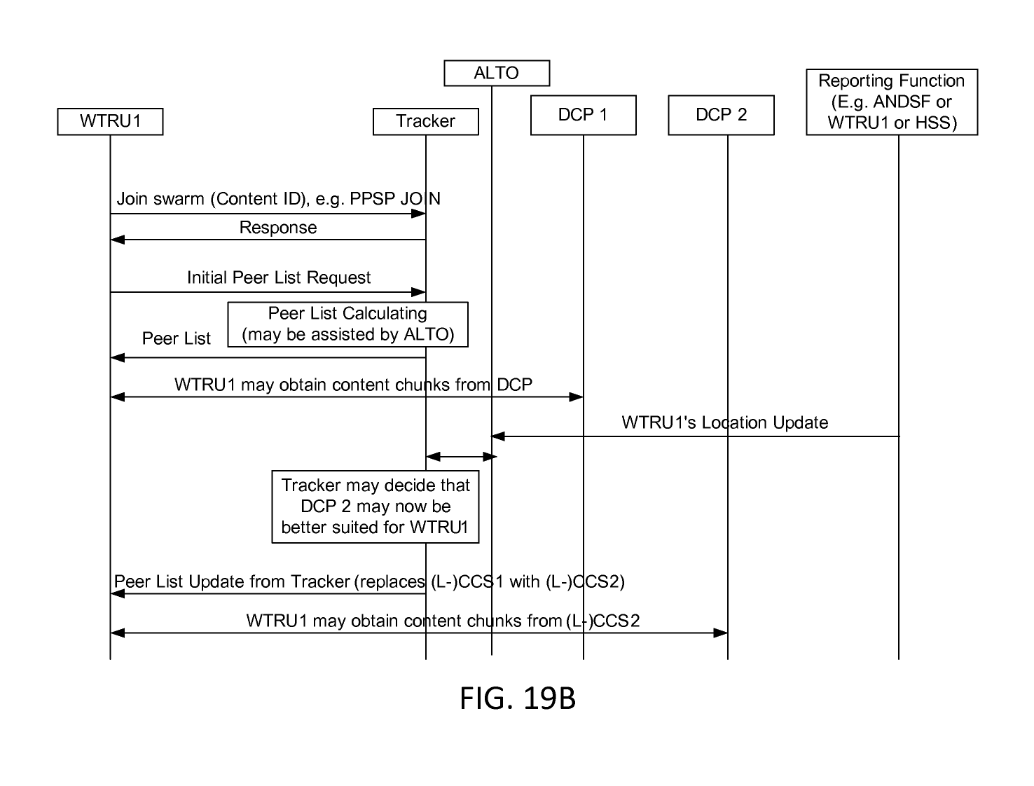

In one or more embodiments, the tracker may receive location information from the network, (e.g., home subscriber server (HSS), ANDSF, etc.) and/or from the WTRU itself. In some embodiments, perhaps based on this location information, the tracker may re-compute a peer list for the WTRU. The tracker may send a peer list update to the WTRU. The peer list change may include, for example, a different CCS/lightweight CCS and/or different peer WTRUs. Alternatively or additionally, WTRU1 (e.g., as depicted in FIG. 19A and/or FIG. 19B), perhaps after detecting a location change, could also request a new (e.g., recently updated) peer list from the tracker.

FIG. 19A is a flow diagram of an example procedure in which a tracker may receive a location update message from a reporting function in an IMS based architecture. In some embodiments, perhaps as a result of receiving the location update message, the tracker may decide to allocate a different dynamic cache peer to WTRU1. Alternatively or additionally, in some embodiments, the tracker may add several regular peers in WTRU1's peer list (e.g., perhaps if WTRU1 moves from using 3G to WLAN).

FIG. 19B is a flow diagram of an example procedure in which a tracker may receive a location update message from a reporting function in a non-IMS based architecture. In FIG. 19B, the ALTO server may receive a location update message from a reporting function and, perhaps as a result, may decide to notify the tracker, which may bring about allocating a different dynamic cache peer to WTRU1 (e.g., this may be an implantation of the “push” model). Alternatively or additionally, for example in a “pull” model, perhaps upon receiving the information the ALTO may update its internal state (and in some embodiments may only update its internal state). At some point WTRU1 may decide to refresh its peer list. Also, the tracker may use the ALTO to generate an updated peer list.

One or more embodiments contemplate that a tracker-based P2P CDS may not be integrated with IMS. One or more embodiments described herein can be combined to enable adapting cellular networks to any over-the-top P2P CDS (e.g., Joost, and/or PPLive). One or more embodiments may enable subscribers to use these services, perhaps without overusing the cellular network resources, when they may be connected through such networks. For example, perhaps if a peer connects to the tracker through a cellular access network, the tracker may detect this (e.g., perhaps directly through configuration and/or by querying, for example, an application layer traffic optimization (ALTO) server). The tracker may decide to associate at least a single dynamic cache per to such a peer. The peer may use an enhanced P2P protocol when communicating with the dynamic cache peer. In some embodiments, the dynamic cache peer and/or the lightweight P2P protocol may apply to a non-IMS P2P CDS. In some embodiments, a non-IMS tracker may receive events from network nodes, (e.g., 3GPP core network nodes such as ANDSF), and react as described herein.

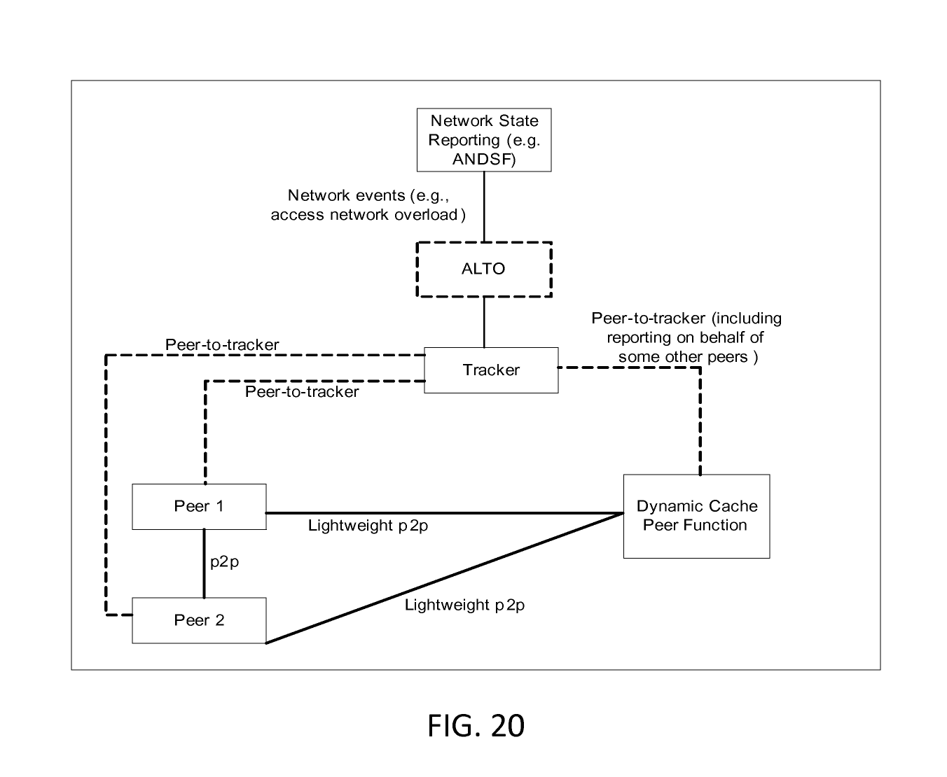

FIG. 20 shows an example architecture of a generic (non-IMS) over-the-top P2P CDS where dynamic cache peers may be deployed. One or more peers may use the lightweight P2P protocol mode. In some embodiments, one or more network events may be used for peer list reconfiguration or update. In some embodiments, the one or more network events may pass through an ALTO service.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

1.-20. (canceled)

21. A device, comprising:
a processor configured to:
receive a request for a peer list from a first wireless transmit/receive unit (WTRU);
determine one or more peer list candidate devices;
place at least a first peer in the peer list;
send the peer list to the first wireless transmit/receive unit (WTRU);
receive a request from the first peer for one or more data segments, the one or more data segments requested by the WTRU;
identify which of the one or more data segments are stored on the first peer;
dynamically obtain any of the one or more data segments not stored on the first peer from at least one other node via a P2P protocol; and
send at least one of the identified one or more data segments, or the obtained one or more data segments to the first WTRU.

22. The device of claim 21, wherein the processor is further configured to:
identify the first peer in the peer list by a flag;
place a second peer in the peer list; and
place a second WTRU in the peer list.

23. The device of claim 21, wherein the processor is further configured to:
place a second peer in the peer list;
associate a first weight parameter with the first peer in the peer list; and
associate a second weight parameter with the second peer in the peer list, the first weight parameter being larger than the second weight parameter.

24. The device of claim 21, wherein the request includes a first indication, and the processor is further configured to:
interpret the first indication such that the device is to function as a dynamic cache peer (DCP) device regarding the request for the one or more data segments.

25. A dynamic cache peer (DCP) capable device, the DCP capable device in communication with a wireless transmit/receive unit (WTRU) and at least one other node, the DCP capable device comprising:
a processor configured to:
receive a request from the WTRU for one or more data segments via a peer-to-peer (P2P) protocol;
identify which of the one or more data segments are stored on the DCP capable device;
dynamically obtain any of the one or more data segments not stored on the DCP capable device from the at least one other node via the P2P protocol; and
send at least one of the identified one or more data segments, or the obtained one or more data segments, to the WTRU via the P2P protocol.

26. The DCP capable device of claim 25, wherein the processor is further configured to implement a lightweight peer-to-peer (P2P) protocol mode, and the request for the one or more data segments is received without a request from the WTRU for a bitmap corresponding to the one or more data segments.

27. The DCP capable device of claim 25, wherein the processor is further configured to implement a lightweight peer-to-peer (P2P) protocol mode, and the request for the one or more data segments includes a second indication for the DCP capable device to operate in the lightweight P2P protocol mode.

28. The DCP capable device of claim 25, wherein the processor is further configured to:
communicate that the DCP capable device can provide the one or more data segments.

29. The DCP capable device of claim 25, wherein the DCP capable device is a SuperPeer device.

30. The DCP capable device of claim 25, wherein the DCP capable device has at least one of: a relatively larger bandwidth capacity than of a non-dynamic cache peer, or a relatively larger processing capacity than of a non-dynamic cache peer.

31. The DCP capable device of claim 25, wherein the processor is further configured to implement a lightweight peer-to-peer (P2P) protocol mode, and the DCP capable device is at least one of: a content cache server (CCS) or a lightweight content cache server (L-CCS).

32. The DCP capable device of claim 25, wherein the request includes a first indication, and the processor is further configured to:
interpret the first indication such that the DCP capable device is to function as a DCP device regarding the request for the one or more data segments.

33. A method for providing a dynamic cache peer (DCP) function, the method comprising:
receiving a request from a wireless transmit/receive unit (WTRU) for one or more data segments via a peer-to-peer (P2P) protocol;
identifying which of the one or more data segments are stored on a DCP capable device;
dynamically obtaining any of the one or more data segments not stored on the DCP capable device from at least one other node in communication with the DCP capable device via the P2P protocol; and
sending at least one of the identified one or more data segments, or the obtained one or more data segments, to the WTRU via the P2P protocol.

34. The method of claim 33, further comprising:
implementing a lightweight peer-to-peer (P2P) protocol mode by the DCP capable device, wherein the request for the one or more data segments is received without a request from the WTRU for a bitmap corresponding to the one or more data segments.

35. The method of claim 33, further comprising:
implementing a lightweight peer-to-peer (P2P) protocol mode by the DCP capable device, wherein the request for the one or more data segments includes a second indication for the DCP device to operate in the lightweight P2P protocol mode.

36. The method of claim 33, further comprising:
communicating, by the DCP capable device, that the one or more data segments can be provided.

37. The method of claim 33, wherein the DCP capable device is a SuperPeer device.

38. The method of claim 33, wherein the DCP capable device has at least one of: a relatively larger bandwidth capacity than of a non-dynamic cache peer, or a relatively larger processing capacity than of a non-dynamic cache peer.

39. The method of claim 33, further comprising:
implementing a lightweight peer-to-peer (P2P) protocol mode by the DCP capable device, wherein the DCP capable device is at least one of: a content cache server (CCS) or a lightweight content cache server (L-CCS).

40. The method of claim 33, wherein the request includes a first indication, and the method further comprises:
interpreting the first indication such that the DCP capable device is to function as a DCP device regarding the request for the one or more data segments.
